(19) United States
(12) Patent Application Publication
(10) Pub. No.: US 2010/0106514 A1
(43) Pub. Date: Apr. 29, 2010

(54) Travel related services via SDARS

(75) Inventor: Stuart A. Cox, Boca Raton, FL (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: Sirius XM Radio Inc., New York, NY (US)

(21) Appl. No.: 12/589,710

(22) Filed: Oct. 26, 2009

Related U.S. Application Data
(60) Provisional application No. 61/108,289, filed on Oct. 24, 2008.
(60) Provisional application No. 61/108,289, filed on Oct. 24, 2008.
(60) Provisional application No. 61/108,293, filed on Oct. 24, 2008.

(51) Int. Cl. G06F 17/30; G01C 21/00; G06Q 30/00; G06F 3/048; G06F 15/16; G08G 1/14

(52) U.S. Cl. 705/1.1; 701/201; 707/705; 715/764; 707/609; 709/226; 340/932.2; 707/E17.107; 707/E17.005

(57) ABSTRACT

Systems and methods of for providing various services, such as parking services, flight services, and fuel services, to a user using a satellite digital audio radio system are provided. Each data service can be provided independently or in any combination to a user, and each can be independently subscribed to by a user, in various exemplary business models. In exemplary embodiments of the present invention, a parking data service, providing, for example, information on parking garages near a certain location and the availability of parking spaces in parking garages can be provided. In exemplary embodiments of the present invention, a flight data services, providing, for example, information such as near real-time updates to changes in arrival and departure statuses of one or more commercial airline flights. In exemplary embodiments of the present invention, a fuel data service, providing, for example, information on fueling stations and the prices and fuel types available at fueling stations, can be provided. In exemplary embodiments of the present invention, such data services can be embedded in an SDARS data stream and made available to users on an SDARS receiver.

### CROSS-REFERENCE TO RELATED APPLICATIONS

This application claims the benefit of each of (i) U.S. Provisional Patent Application No. 61/108,289, filed Oct. 24, 2008 (entitled “PARKING DATA SERVICE”), (ii) U.S. Provisional Patent Application No. 61/108,293, filed Oct. 24, 2008 (entitled “FLIGHT DATA SERVICE”), and (iii) U.S. Provisional Patent Application No. 61/108,284, filed Oct. 24, 2008 (entitled “FUEL DATA SERVICE”), each of which is hereby incorporated by reference herein in its entirety.

### TECHNICAL FIELD

The present invention relates to systems and methods for providing data services to a user using a satellite digital audio radio system, or “SDARS.”

### BACKGROUND OF THE INVENTION

Subscribers to and users of satellite digital radio often additionally consume parking and fuel. Many of them are tourists or business travelers, finding themselves in a foreign city and being concerned about the status and timing of a return flight. SDARS in-vehicle receivers present an excellent platform for delivering to users additional data services, such as, for example, parking data at their intended destination, fueling stations and their costs for fuel along the user's route, and flight status information at one or more proximate airports.

### SUMMARY OF THE INVENTION

Systems and methods of for providing various services, such as parking services, flight services, and fuel services, to a user using a satellite digital audio radio system are provided. Each data service can be provided independently or in any combination to a user, and each can be independently subscribed to by a user, in various exemplary business models. In exemplary embodiments of the present invention, a parking data service, providing, for example, information on parking garages near a certain location and the availability of parking spaces in parking garages can be provided. In exemplary embodiments of the present invention, a flight data services, providing, for example, information such as near real-time updates to changes in arrival and departure statuses of one or more commercial airline flights. In exemplary embodiments of the present invention, a fuel data service, providing, for example, information on fueling stations and the prices and fuel types available at fueling stations, can be provided. In exemplary embodiments of the present invention, such data services can be embedded in an SDARS data stream and made available to users on an SDARS receiver.

### BRIEF DESCRIPTION OF THE DRAWINGS

The above and other aspects and advantages of the invention will become more apparent upon consideration of the following detailed description, taken in conjunction with the accompanying drawings, in which like reference characters refer to like parts throughout, and in which:

FIG. 1 is a simplified block diagram of an illustrative satellite-based system for providing services to a user in accordance with exemplary embodiments of the present invention;

FIG. 2 is a flowchart of an illustrative process for updating a Station Database using Database Messages in accordance with exemplary embodiments of the present invention;

FIG. 3 is an illustrative three-level data encapsulation scheme for Database Updated Messages in accordance with exemplary embodiments of the present invention;

FIG. 4 is a flowchart of an illustrative process for providing travel information to a user using a satellite digital audio radio system in accordance with exemplary embodiments of the present invention; and

FIG. 5 is an exemplary screen shot from an exemplary fuel data service implemented on an SDARS receiver.

### DETAILED DESCRIPTION OF THE INVENTION

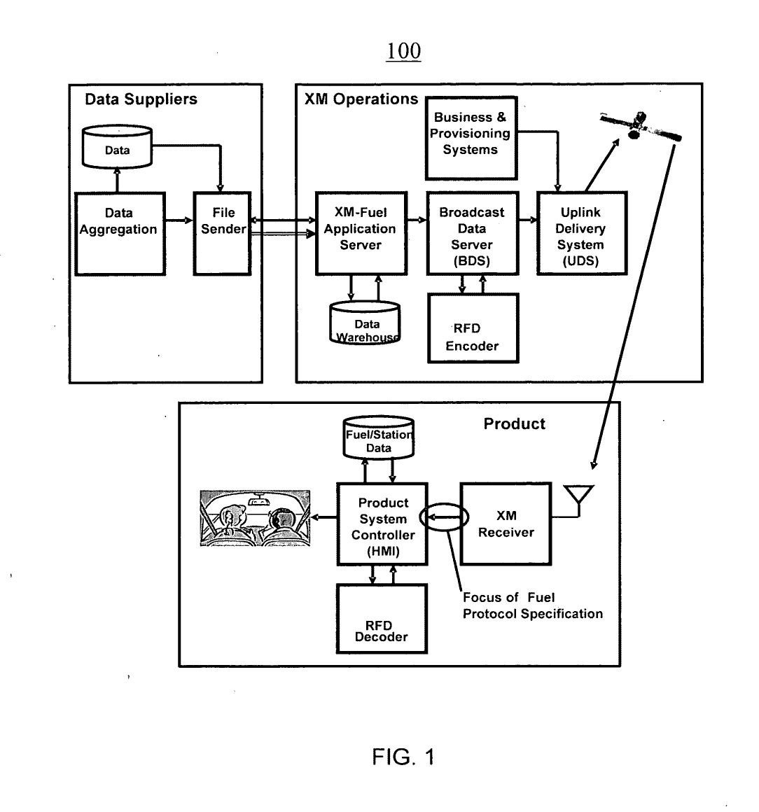

Systems and methods for providing various services, such as parking services, flight services, and fuel services, to a user using a satellite digital audio radio system are provided and described with reference to FIGS. 1-5.

In what follows, details of each of three exemplary data services are provided. Each data service can be provided independently or in any combination to a user, and each can be independently subscribed to by a user, in various exemplary business models. In exemplary embodiments of the present invention, as described in detail below, such data services can be delivered through an SDARS system, and interactively accessed on an SDARS receiver by a user, such as, for example, in a vehicle.

### I. Parking Data Services

In exemplary embodiments of the present invention, systems and methods are provided for providing parking data services, such as, for example, information on parking garages near a certain location and the availability of parking spaces in parking garages.

Table 1 provides definitions that may be used throughout this disclosure, at least with respect to parking data services. It should be understood that any examples provided in the definitions are merely illustrative and not intended to limit embodiments of the invention to the examples.

TABLE 1
Glossary (Parking Data Service)

| Term | Definition |
|---|---|
| 0x | A prefix that may indicate a hexadecimal number. |
| Aftermarket | An “Aftermarket” radio may refer to any radio that is not |
| | factory installed in a vehicle, and therefore can include a |
| | wide range of products including but not limited to |
| | portables, plug & play radios, home radios, and retail- |
| | installed automotive head units. (See also the definition for OEM.) |
| Application ID | Messages for all data services may be wrapped in |
| | packets referred to as Application Packets. These |
| | packets may each begin with a header that includes an |
| | “Application ID” to identify the type of message within |
| | the packet. In this manner, different messages (and |
| | even different data services) can be interleaved on the |
| | same channel (SID), with the Application IDs used to |
| | distinguish them on reception by the product's data parsing |
| | software. |
| Authorized | A channel may be “authorized” for a radio if the radio |
| | has been provided (through over the air signaling or |
| | special factory activation) with authorization to decrypt |
| | and play that channel. |
| Best Practices | A set of recommendations and guidelines, which may be |
| | for a product user interface, which may communicate the |
| | “best practices” for implementing a service in a product |
| | to the product developer community. |
| Data Service | A “Data Service” may involve transmission of data |
| | instead of live audio over the system; for example a |
| | traffic data service (e.g., NavTraffic), a weather data |
| | service (e.g., WX Weather), stock tickers, sports scores, |
| | or channel graphics updates. |
| Data SID | The Service ID (channel) over which a Data Service may |
| | be transmitted. |
| Deck | A type of garage (see definition), which may be a multi- |
| | level coverage garage. |
| Reliable File | A data encoding, transmission, and decoding method |
| Delivery (“RFD”) | where a binary file may be transmitted as a stream of |
| | blocks which may be over time accumulated by a |
| | product. Once a sufficient number of blocks are |
| | accumulated by the product (which may be a cumulative |
| | size a few percent larger than the original binary file |
| | size), the product HMI can execute RFD decoder |
| | software to reconstruct the original binary file. This |
| | method may have the advantage that the product can |
| | gradually accumulate any of the streamed blocks over a |
| | long duration: days, weeks or even months. It may be |
| | particularly useful for transmitting database update files |
| | to a group of products. |
| Garage | In this document a “parking garage” may be a |
| | commercial parking area or establishment, e.g. a |
| | parking lot, parking garage, parking deck, airport park- |
| | and-fly, etc. |
| HMI | Human-Machine Interface. This can include software |
| | that runs the service, controls a receiver, and/or |
| | presents the UI to the user. |
| OEM | OEM may refer to an “automotive OEM.” An OEM radio |
| | may be any radio that is factory installed in a vehicle. |
| | (See also the definition for Aftermarket.) |
| OTA | Over The Air |
| Plug and Play | A class of aftermarket radio that may be installed in a |
| | vehicle by the end user, which may be attached to the outside of |
| | the dash area. |
| PND | Personal Navigation Device |
| POI | Point Of Interest. A POI may refer to an object (such as |
| | a parking garage, gas station, or business) modeled in a |
| | navigation mapping system, with known location relative |
| | to navigable roads or other landmarks in the mapping |
| | system, and potentially other attributes such as name, |
| | address, phone number, etc. |
| Product | A product may be a system that incorporates |
| | functionality described in this document. Examples |
| | include an automotive head unit, an automotive |
| | navigation system that interfaces with a receiver module, |
| | a “plug and play” aftermarket radio, or a Personal |
| | Navigation Device (PND). |
| Protocol | A technical specification of the data format that may be |
| | used to transmit the Parking data or other data service over the air. |
| Recommendation | Specifies an operation that is optional, but not required. |
| RUDE Word | A RUDE (Radio User Digital Entitlement) Word may |
| | refer to a bit field within the receiver chipset that can be |
| | securely changed for individual receivers by signals sent |
| | over the air by the service. It may be used to authorize |
| | certain extended radio capabilities (such as Parking |
| | services discussed herein). Effectively, RUDE words |
| | may provide auxiliary “authorization flags” that can be |
| | read by HMI software to determine service authorization |
| | levels. |
| SID | Service ID. The number assigned to a channel that may |
| | not be visible to the user, which in some embodiments |
| | may take on a value from 0 to 255. Each channel can |
| | be assigned a Channel Number and a SID. The SID for |
| | a channel might change rarely, whereas the |
| | corresponding Channel Number for a channel may be |
| | changed from time to time. |
| Type Approval | A suite of tests that may be run by the developer or |
| | another person, system, or service to verify compliance |
| | with Minimum Features and Functionality. |
| UI | User Interface |

In exemplary embodiments of the present invention, a Parking Service may be provided. The Parking Service can provide near real-time updates as to the number of available parking spaces in parking garages in a suitable geographic area (e.g., the continental US, the continental US and Canada, etc.). The Parking Service may be used, for example, by a car driver approaching an urban area or airport wishing to select a parking garage with the highest probability of having a parking space available.

The Parking Service may provide parking information as a “data service” (i.e., data conveyed over a data channel to a receiver). Software in the receiving product, which may be referred to sometimes as the “HMI”, may be responsible for interpreting this data and presenting it to the user through a user interface (“UI”).

The Parking Service may be provided to products that incorporate a navigation system. Such systems may not only display a list of nearby garages and available spaces based on positional knowledge gained form said navigation system, but may also offer the capability for the user to navigate to a chosen parking garage. However, the Parking Service can also be used by a product without a navigation system or even a GPS. In these embodiments, the Product, for example, may list nearby parking garages and spaces available, based upon some position identification information supplied by the user.

Thee Parking Service may be used as a companion to a traffic data service (e.g., NavTraffic). In general, the markets covered by the Parking Service can correspond to the same markets covered by the traffic data service, with a market launch and expansion plan that mimics that of a given traffic data service.

In some embodiments, providing the Parking Service can involve obtaining parking space availability updates (e.g., from third party data providers), obtaining parking garage information (e.g., addresses, phone numbers, geographic location, brand, total available spaces, etc.) from one or more data providers (e.g., from third party data providers), generating or creating a database of parking garage information (e.g., creating a baseline database for individual development), transmission over systems of updates to available parking spaces, transmission over systems of updates to the database of parking garage information, and provisioning (e.g., authorization and billing) for the Parking Service, or any combination thereof.

In some embodiments, the system for providing a Parking Service can involve a variety of components; including but not limited to a Parking Server, a Parking Console, a Parking Protocol, a Parking UI, and Parking Provisioning. The Parking Server may be maintained by broadcast operations for ingesting parking source data from third party or any other suitable sources, and may format the data for transmission over the air. The Parking Server can include hardware and software similar to servers already in use for other types of data services.

The Parking Console may include a software application used by broadcast operations to compile, edit, and attribute the ingested Parking Server data. A portion of the data flowing through the Parking Server may be processed automatically. Some administrative services, such as compiling updates to parking garage databases and controlling relative bandwidth allocated for parking garage database updates versus parking space availability updates can be controlled through the Parking Console application.

The Parking Protocol can include a technical specification for the format of the Parking data as transmitted over the air to Parking Service-capable products. This specification may be used by developers incorporating Parking Service capability in their product design.

The Parking UI may include a user interface implemented by the Parking Service-capable product, and may be used to present Parking-related data to an end user (e.g., car driver). The UI may or may not vary greatly from product to product. For example, in some embodiments, the Parking UI for a simple Plug and Play Aftermarket device with limited lines of display and memory may be different from the Parking UI for an OEM navigation system incorporating a large touchscreen and hard drive for storage.

The Parking Provisioning may include business system procedures and policies used to authorize use of the Parking Service for specific radios, bill the customer for the services, or any other suitable business-related activities.or needs. In some embodiments, Parking data may be transmitted over a protected or encrypted data channel (SID), which may be the same data channel as used for other services such as NavTraffic, and a RUDE word authorization or other service authorization method can be used to indicate to the receiver whether that receiver is authorized to process and display the Parking data, separate from authorization of the other service(s) on the same data channel.

The Parking Service can provide a variety of different information to aid a user in identifying a garage in which to park. For example, in some scenarios, a user of a Parking Service-enabled product may be unfamiliar with a city, and may therefore be unaware of where he or she can park near a destination. In these scenarios, responsive to a request by the user, the Parking Service can provide a display of parking garage icons on a navigation display. The user may pan the display to the destination to identify a nearby parking garage. This way, the Parking Service may provide information on a garage, allowing the user to be confident in the direction he or she is heading in an unfamiliar area.

In some embodiments, a Parking Service may indicate the availability of parking in garages near a user's destination. Automatically or in responsive to a request by the user, the Parking Service can provide a list or other visual display of the garages in the area near his or her destination. The display may visually indicate which garages include available parking. For example, garages that are full or nearly full may be highlighted in red while garages that are not full or near full may be highlighted in green. This way, the user can quickly and easily identify which garage to drive towards. It should be understood that the Parking UI can use any other suitable technique for visually distinguishing garages with available parking spaces from those without or substantially without available parking spaces, such as using bolding, color, size, or font of text or using different icons, for example.

In some scenarios, a user of a Parking Service-enabled product may want to locate a place to park that is cheap. Responsive to a user request, the Parking Service may provide pricing information for garages near the user's destination and may provide information on how far away each garage is from the destination. This way, the user can balance how much he or she is willing to spend to walking distance. For example, the Parking Service may enable a user to identify a garage farther away that might be considerably cheaper.

In some scenarios, responsive to a user request, the Parking Service may provide data on the hours of operation of garages near the user's destination. This way, if the user needs to park for a certain amount of time or during a certain day or certain part of day, the user can determine which garage may be open during the duration of the user's stay at the destination.

In some embodiments, the Parking Service may provide instructions on how to reach an available parking deck or lot. Responsive to receiving the user selection, the Parking Service may place the car's navigation system into a routing mode and may provide the user with guidance (e.g., turn-by-turn guidance) to a selected deck or lot. This way, the user may easily navigate through unfamiliar or difficult-to-navigate streets to reach the deck or lot.

In some embodiments, the Parking Service may provide instructions on how to reach an available parking space. For example, the Parking Service may provide a display indicating which spaces in a garage are available, and may allow user to select an area of a garage with available spaces (e.g., by providing a selectable “GO” button). Responsive to receiving the user selection, the Parking Service may place the car's navigation system into a routing mode and may provide the user with guidance (e.g., turn-by-turn guidance) to the selected area. This way, the user may easily navigate through unfamiliar or difficult-to-navigate garages.

In some embodiments, the Parking Service may allow a user to select and save a list of “preferred parking garages.” The list may include, for example, garages that the user commonly parks at (e.g., near a work location). The Parking Service may display information about the garages in the list upon request, such as available parking spaces in those garages.

The Parking Service may automatically expand the garages reported to the user. That is, without a specific request by the user, the Parking Service may maintain up-to-date information on garages. The Parking Service can, for example, add any new garages that may open.

As discussed above, the Parking Service may include a Parking Protocol that may specify the over-the-air protocol for transmitting Parking data. To support such a protocol, the Parking Service may utilize a Parking Garage Database, Parking Garage Database Update Messages, and Parking Space Messages. The Parking Garage Database may include a database of parking garage attributes (e.g., address, telephone number, location, brand, total spaces, etc.), which may be maintained by the HMI in persistent, updatable storage (e.g., flash or hard drive). A version of this database, referred to sometimes as the Parking Baseline Garage Database, may be shipped with the HMI at the time the product is shipped or as part of a vehicle map update.

As described in greater detail below, the Parking Garage Database Update Message may be an over-the-air message containing updates to the Parking Baseline Garage Database. A product can optionally use this information to update their local copies of the Parking Garage Database with changes, such as new garages, change in brand for an existing garage, change in total spaces offered by a garage, and the like. In some embodiments, these changes may be transmitted quarterly using limited bandwidth for background accumulation by the product.

As described in greater detail below, the Parking Spaces Message may be an over-the-air message containing current available parking spaces for each of the active garages in the Parking Garage Database. In some embodiments, this data may be transmitted relatively frequently, so a product may have the latest space availability within a few minutes of powering on and as space availability changes.

Returning to the Parking Garage Database, the Parking Garage Database may be used to store Garage Data, Garage Brands, Service Banners, or any combination thereof. Tables 2-4 (provided below) show illustrative attributes of Garage Data, Garage Brands, and Service Banners, respectively, that may be stored in the Parking Garage Database. It should be understood that the attributes provided in these tables are merely illustrative, any additional attributes may be added, and any of the listed attributes may be removed or modified (e.g., use a different storage format, include a different number of bits, bytes, chars, etc., or any other suitable attribute modification).

Table 2 below may illustrate attributes that may be stored for each reported garage.

TABLE 2
Garage Data Record

| Attribute | Description | Format | Length | |
|---|---|---|---|---|
| GARAGE_XMP_ID | Identifier for the garage | Integer | 14 | bits |
| | used in Parking Spaces | | | |
| | Messages and Parking | | | |
| | Garage Database Update | | | |
| | Messages. | | | |
| | 1 to 15,000 | | | |
| GARAGE_POI_ID | Optional cross-reference to | Integer | 8 | Bytes |
| | a global POI identifier, for | | | |
| | associating the garage to a | | | |
| | POI in a mapping database. | | | |
| GARAGE_LAT | Latitude of the garage | Binary | 4 | bytes |
| GARAGE_LONG | Longitude of the garage | Binary | 4 | bytes |
| GARAGE_NAME | Common name of garage | Text | 32 | chars |
| | (e.g., “AAA Parking”) | | | |
| GARAGE_BRAND | Brand of garage | Binary | 2 | bytes |
| | (BRAND_CODE), or 0 if | | | |
| | garage does not possess a | | | |
| | common brand. | | | |
| GARAGE_ADR_STREET | Garage Address - Street | Text | 32 | chars |
| GARAGE_ADR_CITY | Garage Address - City | Text | 32 | chars |
| GARAGE_ADR_STATE | Garage Address - US State | Text | 2 | chars |
| | or Canadian Province | | | |
| | Abbreviation (or any other | | | |
| | appropriate country or | | | |
| | regional terminology) | | | |
| GARAGE_ADR_ZIP | Garage Zip Code (e.g., 5 | Text | 6 | chars |
| | digit US Zip Code or 6 | | | |
| | character Canadian | | | |
| | Province Code) | | | |
| GARAGE_PHONE | Garage Telephone Number | BCD | 10 | bytes |
| GARAGE_TOTAL_SPACES | Total number of spaces at | Integer | 2 | bytes |
| | this garage | | | |
| GARAGE_SERVICES | Special services, which may | Binary | 1 | byte |
| | be present if corresponding | Array | | |
| | bit is 1, undetermined if bit | | | |
| | is 0: | | | |
| | b0: Covered | | | |
| | b1: Security | | | |
| | b2: Valet | | | |
| | b3: Car Wash | | | |
| | b4: Serves an airport | | | |
| | b5: Truck parking available | | | |
| | b5-b7: RFU | | | |
| | (if bn = 1, the corresponding | | | |
| | service is available at the | | | |
| | garage; if bn = 0, the service | | | |
| | may or may not be available | | | |
| | at the garage.) | | | |
| GARAGE_DAILY_RATE | Normal Weekday Daily | Integer | 2 | bytes |
| | Rate, in cents (e.g., $20 | | | |
| | represented as 2,000) | | | |
| | 0 if Daily Rate unspecified. | | | |
| | Bit 15 = RFU | | | |
| GARAGE_HOURLY_RATE | Normal Weekday Daily | Integer | 2 | bytes |
| | Rate, in cents (e.g., $8 | | | |
| | represented as 8,000) | | | |
| | 0 if Hourly Rate unspecified. | | | |
| | Bits 14-15 = RFU | | | |
| GARAGE_WEEKDAY | Normal weekday open and | Binary | 1 | byte |
| | close time encoded as: | | | |
| | b0:b3 = Open hour (0-15) | | | |
| | b4:b7 - Close hour (hour- | | | |
| | 9) | | | |
| | 0x00 = Open 24 hours | | | |
| | 0xFF = Hours unspecified | | | |
| GARAGE_SAT | Normal Saturday open and | Binary | 1 | byte |
| | close time encoded as: | | | |
| | b0:b3 = Open hour (0-15) | | | |
| | b4:b7 - Close hour (hour- | | | |
| | 9) | | | |
| | 0x00 = Open 24 hours | | | |
| | 0xFF = Hours unspecified | | | |
| GARAGE_SUN | Normal Sunday open and | Binary | 1 | byte |
| | close time encoded as: | | | |
| | b0:b3 = Open hour (0-15) | | | |
| | b4:b7 —Close hour (hour- | | | |
| | 9) | | | |
| | 0x00 = Open 24 hours | | | |
| | 0xFF = Hours unspecified | | | |
| GARAGE_COMMENT | Text comment for optional | Text | 16 | chars |
| | use to state special rates, | | | |
| | unique services, etc. | | | |
| GARAGE_UPDATED | Date this Garage record | Integer | 2 | bytes |
| | was last updated. | | | |
| | Encoded as integer days | | | |
| | since Jan. 1, 2008 | | | |
| | Bits 13-15 = RFU | | | |

The GARAGE_POI_ID field may support associating reported garages directly to POIs within a mapping database, for more accurate navigation to the garage by a navigation system. However, due to the time and effort that may be necessary to establish such map POI associations acceptable for various involved map database vendors and navigation equipment providers, the Parking Service may be implemented without these direct POI associations. Instead, the Parking Service may use lat/long positioning maintained in GARAGE_LAT and GARAGE_LONG. Thus, the service protocol may be designed to support garage positioning using simple lat/long data, or using a more sophisticated reference to a navigation system's POI database, or both (e.g., most garages using POI references, but “new” garages positioned with lat/long data).

Common Parking Garage Brands may be maintained in a table in which an integer brand code may be associated with a text name and optionally graphic logos, as illustrated in Table 3 below.

TABLE 3
Brand Codes and Attributes

| | | | Max |
|---|---|---|---|
| Attribute | Description | Format | Length |
| BRAND_CODE | Index for this brand. | Integer | 2 bytes |
| | | 0-1023 | |
| BRAND_NAME | Name of the brand | Text | 24 chars |
| | (e.g., “Central | | |
| | Parking”, | | |
| | “AAA Parking”) | | |
| BRAND_LOGO_SMALL | Small PNG thumbnail | PNG | Variable |
| | for brand, which may | | |
| | be useful for a map | | |
| | icon or small | | |
| | color display. | | |
| BRAND_LOGO_LARGE | Larger PNG thumbnail | PNG | Variable |
| | for brand, which may | | |
| | be useful for | | |
| | displaying with | | |
| | a list of garages | | |

Service banner data may include a set of text and logos for optional display as a service banner. The banner can be used as simply a title of the service, or optionally to include a sponsor name (e.g., “Acme Parking Report”) to defray the cost of the service. In some embodiments, support for multiple banner records can be provided to allow for different banners to be used for different classes of products, different manufacturers, different OEMs, etc. Table 4 below shows the illustrative contents of each banner record.

TABLE 4
Service Banner Records

| | | | Max |
|---|---|---|---|
| Attribute | Description | Format | Length |
| BANNER_CODE | Index for this | Integer | 1 byte |
| | banner. | 0-255 | |
| BANNER_NAME | Text for the banner. | Text | 32 chars |
| BANNER_LOGO_SMALL | Small PNG | PNG | Variable |
| | thumbnail for | | |
| | optional display of | | |
| | a logo or service | | |
| | symbol with the | | |
| | banner text. | | |
| BANNER_LOGO_LARGE | Larger PNG | PNG | Variable |
| | thumbnail for | | |
| | optional display of | | |
| | a logo or service | | |
| | symbol with the | | |
| | banner text. | | |

As discussed above, updates to portions of the Parking Garage Database may be sent in Parking Garage Database Update Messages. These update messages may contain Update Files encoded with Reliable File Delivery. In some embodiments, each record in an Update File may contain the GARAGE_XMP_ID of the affected garage, followed by any changed or added fields. For new garages, all fields described in Table 2: Garage Data Record may be included in the update record. In some embodiments, for updates to existing garages, only the changed fields may be included in the record.

The Parking Garage Database Update Messages may support special treatment of the GARAGE_UPDATE fields. If the data, such as rates and hours of operation, are known to be valid for a garage at the time the database is updated, this date can be efficiently updated to the current date for that garage during the database update cycle, even if no fields have actually changed value for that garage. This may be important so the user can have confidence information about that garage, such as rates and hours of operation, is up-to-date. It should be understood that the Parking Garage Database Update Message may also include updates to the Brand Codes and Service Banners, and their associated attributes.

In some embodiments, the maximum size of an Update File after reconstruction using the Reliable File Delivery decoder may be 2 MBytes.

Use of the Parking Garage Update Messages may be optional. Alternatively, an OEM can apply updates to the Garage Database through manual updates (e.g., updates provided to a customer when updating the navigation mapping system). To process the Parking Garage Update Messages, the HMI may incorporate Reliable File Delivery decoding software, so a modest license fee may apply. The tradeoff may therefore be the user convenience of receiving updates automatically (Spaces Messages for new garages may not be used until the Garage Database is updated with the new garages), versus avoiding use of Reliable File Delivery. If Reliable File Delivery is already included in the HMI software to support other data services, there may be no incremental licensing fee for using it for the Parking Service.

The protocol for the Parking Garage Database Update Messages may allow for extensibility without affecting earlier Parking product implementations. For example, a future version of the Parking Service may add additional fields to the Parking Garage Database, and the protocol for the Parking Garage Update Messages may be likewise extended to support update of these new fields. However, older Parking Service implementations may ignore the new fields and continue to process known fields without any issue.

As discussed above, Parking Spaces Messages may be used to deliver near real-time updates regarding availability of parking spaces. In some embodiments, the availability of parking spaces may be provided in accordance with the attributes provided in Table 5 below. The format of the Parking Spaces Message can incorporate various compression techniques to assure this information may utilize minimal bandwidth, and can therefore be retransmitted as quickly as possible within the allocated bandwidth. Table 5 may describe only the logical content of these messages if this data was sent in relatively uncompressed format. Transmission size with compression may use slightly over 1.25 bytes per garage.

TABLE 5
Available Parking Spaces Data Elements

| Attribute | Description | Format | Length |
|---|---|---|---|
| GARAGE_XMP_ID | Identifier for a reported | Integer | 14 bits |
| | garage, linking to the | | |
| | Garage Database. | | |
| SPACES_AVAIL | Number of spaces available | Integer | 9 bits |
| | (0 to 500). | | |
| | Also, reserved special | | |
| | coding may be used to | | |
| | indicate: | | |
| | *“Over 500 spaces | | |
| | available” | | |
| | *“Limited spaces available” | | |
| | *“Full” | | |
| | *“No Information” | | |

The protocol for the Parking Spaces Messages may allow for extensibility without affecting early Parking product implementations. For example, a future version of the Parking Service may add additional fields to the Parking Spaces Messages, such as number of available covered versus uncovered spaces available. However, older implementations can ignore the new fields and continue to process known fields without any issue.

The Parking Service may use any suitable technique or provide any suitable interface for presenting parking information to a user. In some embodiments, the Product Service may select candidate garages to present to the user, such as in response to a user request to view potential garages to park at. The Parking Service may select garages using any number of suitable factors. Optionally, the selection may be based on GPS proximity. Here, a current vehicle location, which may be provided by a vehicle GPS function (e.g., in a navigation, or safety & security system, or incorporated in the SDARS receiver), may be used to locate the closest garages. Optionally, the selection may be based on proximity to the destination. Here, candidate garages may be located based on their proximity to a destination or POI identified through the navigation system. In some embodiments, the selection of candidate garages may be made based on market. For products that may not have access to the vehicle location, a list of candidate garages may be assembled by first selecting a city from a list, then an area of the city (e.g., North, Northeast, East, etc.). For example, this may be implemented using a separate database that associates station zip codes with the market areas.

In addition to the above-described selection mechanisms, the product can offer additional filtering of candidate garages based on various attributes (e.g., attributes that may be selected by a user), including, but not limited to, hours of operation (e.g., including automatic exclusion of garages not open on the current day (e.g., not open on Sunday while traveling on Sunday)), favorite garages, garages serving an airport, garages offering covered parking, garages offering security, garages offering valet parking, garages offering car wash service, garages allowing truck parking, omitting garages in track backward direction, and the like.

In some embodiments, the Parking Service may provide a textual or graphical representation of garages, such as in response to a user request to view nearby garages on a navigation system. The Parking Service may provide the representation of garages using any suitable format, such as in a Garage Map or a Garage List. A Garage Map may show garages as highlighted POIs on a navigation map, for example.

A Garage List may show garages in a list,.such as a prioritized list. The list may be prioritized or ordered using any suitable technique or based on any suitable variety of factors. For example, the list may be ordered based on the current vehicle location (e.g., in order of distance from the vehicle, track forward garages (i.e., in the current direction of travel), on the same side of the road as the current direction of travel, or based on estimated calculated navigation route (i.e., list the garages with shortest travel first)). The list order may be selected based on proximity to a destination or POI, such as by prioritizing garages in order of distance from the destination. Alternatively or in addition, the garages in the list may be prioritized from highest to lowest number of available spaces or based on a preferred brand (e.g., as previously selected by the user through User Preferences).

The Parking Service may provide any suitable information about the garages included in a Garage Map or a Garage List. For example, the Parking Service may select a number of attributes to include in the Garage Map or List for each displayed garage, where the amount of information may be based on the display space or UI capabilities. The displayed attributes can include, for example, the space available in the garage (e.g., where the garage may be further highlighted with color to visually represent whether space is limited (e.g., red for less than 10 spaces, yellow for 10 to 30 available spaces, or green for more than 30 available spaces)), garage name, garage brand, garage logo (e.g., a large or small logo), distance to garage, direction of garage relative to track forward, garage address, garage rates (e.g., normal daily weekday rates, normal daily weekend rates, normal hourly weekday rates, and/or normal hourly weekend rates, where the garage may be further highlighted with color to visually represent whether it is more or less expensive than other local garages), hours of operation (e.g., including open or closed on Saturday and Sunday), garage comments (i.e., if non-blank, this string may contain additional information such as after-hours rates, early-bird specials or special services), garage services (e.g., covered parking, car wash, security, valet parking, truck parking available), information on whether the garage serves an airport, or any combination thereof.

In some embodiments, if data such as rates and hours of operation are displayed, the product may also display the date the garage information was last updated (e.g., GARAGE_UPDATE field). This way, the user can judge if rates may be subject to change.

The UI for the Parking Service may include any other suitable options to enhance user ease and experience with the Parking Service. For example, to avoid driver distraction while the vehicle is moving, the Parking Service-enabled product may offer the ability to set user preferences for selecting garages, and for filtering and ordering resulting garage selection lists. Any of the above-described attributes and list order priorities may be affected by the user preferences. As another option, the Parking Service-enabled product may offer the ability for the user to designate a garage identified during a search or on the navigation map as a “favorite”. Thereafter, the user may be provided with a favorites list to quickly view and compare spaces available at their favorite garages. Furthermore, groups of favorites could be defined, such as “work commute” or “airport drive” favorite garages, so these garages could be recalled easily depending on the current trip route. As an example of another option, to avoid driver distraction, a voice control system and text to speech response can be used to make it easier to direct the product to perform more complex garage searches.

The Parking Service may be employed across any suitably-sized area or areas. For example, the Parking Service may be supported for any number (e.g., 20, 100, 500, 1,000, 7,000, etc.) major urban markets in the United States or abroad. It should be understood that any suitable adjustments or implementation decisions may be made based on how expansive the Parking Service is intended to cover.

In some embodiments, the Parking service data may be transmitted over the same data SID as other data services, such as, for example, NavTraffic (SID 255). Parking messages may be assigned different Application IDs from NavTraffic messages, so they can be uniquely identified (and may be effectively ignored by older products that process NavTraffic only).

In some embodiments, approximately 1 kbps or less of channel SID 255 bandwidth may be used for Parking messages, which may be allocated between Parking Space Messages and Parking Garage Database Update Messages. Approximately 0.5 kbps or less may be used for transmission of Parking Spaces Messages. This bandwidth allocation can provide retransmission of the available spaces for 500+ parking garages (“update cycle duration”) about once every 30 seconds or for 7,000 parking garages about once every 2 to 3 minutes. Approximately 0.5 kbps or less may be used for transmission of Parking Garage Database Update Messages, containing Reliable File Delivery-encoded data components. This may support reception of an Update File with cumulative reception times of about 50 minutes per 1000 new garage additions, supporting a quarterly (3 months) update cycle.

A product can include a number of modules for supporting the Parking Service. In some embodiments, the product can include an SDARS receiver module. The product can further include a receiver module using a CMOS90 chipset (or later generation), for example, which may make use of RUDE Word service authorization.

The product may include electrical connections between the receiver chipset or module and the product's controller for a low-speed data port (LSDP) or high-speed data port (HSDP). This connection may convey the transmitted Parking data from the receiver to the products HMI for processing and storage. The product may include non-volatile storage (e.g., flash or hard drive) to maintain an initial Parking Garage Database. For example, the non-volatile storage may have a capacity of approximately 160 KBytes, with potential to grow due to updates to approximately 1.2 Mbytes or more. Also, the product can include other types of storage (e.g., RAM, flash, or hard drive) to maintain the latest Parking Spaces data received over the air. The storage may have a capacity of, for example, approximately 1.5 KBytes with growth to 10 Kbytes or more. This data may not be used for long, so the data may be stored in volatile storage instead of a non-volatile storage.

In some embodiments, Parking Garage Database Update Messages may be supported. In these embodiments, Reliable File Delivery decoder software may be used in the HMI to reconstruct Parking Garage Database Update Files from data cumulatively received over the air, with sufficient RAM resources to decode a file size of maximum 2 MBytes. The product may, in some embodiments, include GPS resources to determine the current vehicle location relative to Parking garage locations and/or a navigation subsystem capable of accepting the location of a user-selected parking garage for trip routing.

The product may be configured to have sufficient HMI processing capabilities to parse data received from the receiver data port, store received Parking Spaces in local HMI memory, respond to user interactions to filter, view, sort, and select local parking garages and display available spaces. In embodiments where Parking Garage Database Updated Messages are supported, the product may be further configured to have sufficient HMI processing capabilities to (1) accumulate incrementally received packets for Parking Garage Database Updates, and, when sufficient packets are received, execute the Reliable File Delivery decoder to reconstruct a full Garage Database Update File, and (2) apply a received Garage Database Update File against the HMI's local Garage Database.

Next described is an exemplary Flight Data Services functionality according to exemplary embodiments of the present invention.

### II. Flight Data Services

In other embodiments, systems and methods are provided for providing flight data services. For example, information such as near real-time updates to changes in arrival and departure statuses of one or more commercial airline flights can be provided.

Table 6 (below) may provide definitions used throughout this disclosure, at least with respect to flight data services. It should be understood that any examples provided in the definitions are merely illustrative and not intended to limit embodiments of the invention to the examples.

TABLE 6
Glossary (Flight Data Service)

| Term | Definition |
|---|---|
| 0x | A prefix that can indicate a hexadecimal number. |
| Aftermarket | An Aftermarket radio can refer to a radio that is not |
| | factory installed in a vehicle and can include a wide |
| | range of products such as, for example, portable radios, |
| | plug & play radios, home radios, retail-installed |
| | automotive head units, or any other suitable radio. (See also the |
| | definition for OEM.) |
| Application ID | Messages for data services can be wrapped in packets |
| | (e.g., “Application Packets”). These packets can each |
| | begin with a header that can include an Application ID to |
| | identify the type of message within the packet. In this |
| | manner, different messages (e.g., and different data |
| | services) can be interleaved on the same channel |
| | (“SID”). The Application ID's can be used to distinguish |
| | the messages upon reception by the product's data parsing software. |
| Authorized | A channel can be authorized for a radio if that radio has |
| | been provided (e.g., through over the air signaling, |
| | through special factory activation, or through any other |
| | suitable way) with authorization to decrypt and play that |
| | channel. |
| Best Practices | A set of recommendations and guidelines, typically for a |
| | product user interface, can communicate the “best |
| | practices” for implementing a service in a product to the |
| | product developer community. |
| Codeshare | Codeshare can refer to a practice where an airline |
| | remarkets a flight operated by an original airline, and |
| | assigns the flight a different flight number than the one |
| | assigned by the original airline. |
| Data Service | A radio Data Service can involve transmission of data |
| | (e.g., instead of live audio) over the radio system. The |
| | data can include, for example, traffic data, weather data, |
| | stock ticker data, sports data, channel graphics updates, |
| | or any other suitable data. |
| Data SID | Data SID can refer to the Service ID (channel) over |
| | which a radio Data Service is transmitted. |
| Reliable File | Reliable File Delivery can refer to a data encoding, |
| Delivery | transmission, and decoding method where a binary file |
| | can be transmitted as a stream of blocks which are over |
| | time accumulated by a product. Once a sufficient |
| | number of blocks are accumulated by the product |
| | (typically a cumulative size a few percent larger than the |
| | original binary file size), the product HMI can execute |
| | Reliable File Delivery decoder software to reconstruct |
| | the original binary file. This method can have the |
| | advantage that the product can gradually accumulate |
| | any of the streamed blocks over a long duration (e.g., |
| | days, weeks, months and the like). It can, for example, |
| | be useful for transmitting database update files to a group of |
| | products. |
| HMI | Human-Machine Interface. This software can run in a |
| | Flight Status service-capable product and control a |
| | receiver module, and can presents the User Interface |
| | (“UI”) to the user. |
| IATA | International Air Transport Association. This body can |
| | establish airline and airport codes, guidelines for flight |
| | number assignments used around the world, and other |
| | flight related information |
| OEM | This term can refer to “Automotive OEM.” An OEM |
| | radio can include a radio that is factory installed in a |
| | vehicle. (See also the definition for Aftermarket.) |
| OTA | Over The Air |
| Plug and Play | This can include a class of aftermarket radios that may |
| | be installed in a vehicle by the end user, and can |
| | typically be attached to the outside of the dash area. |
| PND | Personal Navigation Device. |
| POI | Point Of Interest. A POI can include an object (e.g., an |
| | airport, gas station, business, or other suitable object) |
| | modeled in a navigation mapping system. The POI Can |
| | include a known location relative to navigable roads in |
| | the mapping system, and can include other attributes |
| | such as name, address, phone number, etc. |
| Product | A product is a system that can incorporate functionality |
| | described in this document. For example, a product can |
| | include an automotive head unit, an automotive |
| | navigation system that interfaces with a receiver module, |
| | a “plug and play” aftermarket radio, or a Personal |
| | Navigation Device (PND) with Flight Status server |
| | capability. |
| Protocol | A protocol can include a technical specification of the |
| | data format used to transmit the Flights data over the air. |
| Recommendation | Specifies an operation that is optional, but not required. |
| RFU | Reserved for Future Use. |
| SID | Service ID. This can refer to a number assigned to a |
| | radio channel that may not be visible to the user, which |
| | in some embodiments may take on a value from 0 to |
| | 255. Each channel can be assigned a Channel Number |
| | and a SID. The SID for a channel may rarely change, |
| | whereas radio service provider may change the |
| | corresponding Channel Number for a channel from time |
| | to time. |
| Type Approval | A suite of tests that can be run by the developer and the |
| | radio service provider to verify compliance with Minimum |
| | Features and Functionality. |
| UI | User Interface |
| Use Case | An example of the service application that can typically |
| | involve exemplary customers, and can be useful for |
| | deriving possible service requirements. |

In some embodiments, a Flight Status Service may be provided. The Flight Status service can provide near real-time updates to changes in arrival and departure statuses of one or more commercial airline flights that, for example, fly in and out of a suitable area (e.g., major United States airports, all United States airports, Canada, other countries, any other suitable location, or any combination of the above). This may, for example, be used by car drivers and passengers when they are on their way to an airport to catch a flight out or when they are on their way to pick up someone arriving from an incoming flight.

Flight Status services can provide the flight information as a “data service” (e.g., data conveyed over a radio data channel to a radio receiver). Software in the receiving Flight Status service-capable product (the “HMI”) can be responsible for interpreting this data and presenting it to the user through a user interface (“UI”).

This invention can advantageously allow for acquisition of flight status updates from third party data providers, acquisition of flight schedule information (e.g., airline information, flight numbers, departure/arrival airports, schedule departure/arrive times and dates, and the like) from third party data providers, or both. As another example, this invention can advantageously allow for provision of a baseline database of airline and airport information to radio product developers. As yet another example, this can allow for transmission over the Flight Status system of updates of flight arrival/departure statuses, transmission over the Flight Status system of updates to a database of flight schedule information, and transmission over the Flight Status system of updates to the baseline database of airline and airport information. Moreover, this can advantageously provide for provisioning (e.g., authorization and billing) for use of the Flight Status service.

In some embodiments, the system for providing a Flight Status Service can involve a variety of components, including but not limited to a Flights Server, a Flights Console, a Flights Protocol, a Flights UI, and a Flights Provisioning.

In some embodiments, the Flight Status system can include a Flights Server. The Flights Server can include a server maintained by radio broadcast operations that ingests flight source data from an appropriate source (e.g., third-party sources, internal sources, and the like) and can format the data for transmission over the air. The Flights Server can, for example, involve any suitable hardware and software for implementing this system.

In some embodiments, the Flight Status system can include a Flights Console. The Flights Console can include a software application used by radio broadcast operations staff to, for example, compile, edit, and attribute the ingested flights data, as well as control the operation of certain aspects of the Flights Server. In some embodiments, data flowing through the Flights Server can be processed automatically. In some embodiments, administrative services, such as compiling updates to airline and airport databases and controlling relative bandwidth allocated for flight database updates versus flight status updates, can be controlled through the Flights Console application.

In some embodiments, the Flight Status system can include a Flights Protocol. The Flights Protocol can include a technical specification for describing the format of the flights data as transmitted over the air to products. The specification can be used by, for example, developers incorporating Flights Status service capability in their product design.

In some embodiments, the Flight Status system can include a Flights UI. The Flights UI can include a user interface implemented by the Flight Status service-capable product presenting the flights data to the end user. The UI may, for example, vary greatly from product to product.

In some embodiments, the Flight Status system can include a Flights Provisioning. The Flights Provisioning can include, for example, business system procedures and policies used by the Flight Status service to authorize use of flights for specific radios, and to bill the customer for the services.

The Flight Status Service can provide a variety of different information items to a user in the context of airline flights. For example, the Flight Status service may provide a user with information such as the time when their flight is departing. In this scenario, a user can view flight departure information while they are in-transit to the airport (e.g., while driving to the airport). As another example, the Flight Status service can beneficially provide a user with information such as when their acquaintance's flight is arriving (e.g., when the user is scheduled to pick up the acquaintance at the airport). As yet another example, the Flight Status service can provide a user with information such as which flight the user or an acquaintance is scheduled to use.

In some embodiments, the Flight Status service can include various data components. For example, these components can be used to support an over-the-air protocol for transmitting the Flights Data. These components can include, but are not limited to, data components such as Flights Databases, Flights Schedule Messages, Flights Status Messages, and Flight Delays Messages.

A Flights Database can include a set of tables maintained by the HMI in persistent, updatable storage (e.g. a flash drive, hard drive, or the like). The Flights Database can include, for example, an Airline Database (e.g., including airline names, two-letter codes, logos, phone numbers, and the like), an Airport Database (e.g., including airport names, three-letter codes, navigable address, latitude/longitude location., and the like), a Flight Schedule Database (e.g., including arrival/destination airports, arrival/departure schedule times, airline identifiers, flight numbers, code-sharing references, and the like), a Codeshare Database (e.g., including auxiliary flight schedule data, codeshare flights data, and the like), a Service Banners Database (e.g., including attributes for text and logo banners), or any other suitable flights database.

An exemplary Airline Database is shown below in Table 7.

TABLE 7
Airline Database

| | | | Max |
|---|---|---|---|
| Attribute | Description | Format | Length |
| AIRLINE_XMA_ID | Identifier for the | Integer | 8 bits |
| | airline that can be | | |
| | used in lights | | |
| | Status Messages | | |
| | (e.g., can include | | |
| | values from 1 to 200) | | |
| AIRLINE_IATA_CODE | Two-letter code for the | Text | 2 chars |
| | airline assigned by the | | |
| | IATA (e.g. “DL”) | | |
| AIRLINE_NAME_SHORT | Short name of the | Text | 10 chars |
| | airline (e.g. “Delta”) | | |
| AIRLINE_NAME_FULL | Long name of the | Text | 32 chars |
| | airline (e.g. “Delta | | |
| | Airlines”) | | |
| AIRLINE_PHONE | Phone number for | BCD | 10 bytes |
| | general airline contact | | |
| AIRLINE_LOGO_SMALL | Small thumbnail (e.g., | PNG | Varia- |
| | PNG format) for | | ble |
| | airline. This can be | | |
| | used in, for example, | | |
| | a map icon or | | |
| | small color display. | | |
| AIRLINE_LOGO_LARGE | Larger thumbnail for | PNG | Varia- |
| | airline. Can be used in, | | ble |
| | for example, larger | | |
| | displays. | | |

An exemplary Airport Database is shown below in Table 8.

TABLE 8
Airport Database

| Attribute | Description | Format | Length |
|---|---|---|---|
| AIRPORT_XMA_ID | Identifier for the | Integer | 14 bits |
| | airpor tused in | | |
| | Flights Status | | |
| | Messages. (e.g., can | | |
| | include values from | | |
| | 1 to 10,000) | | |
| AIRPORT_POI_ID | Cross-reference to a | integer | 8 Bytes |
| | global POI identifier. | | |
| | Can be used for | | |
| | associating the airport | | |
| | to a POI in a mapping | | |
| | database. | | |
| AIRPORT_LAT | Latitude of the airport | Binary | 4 bytes |
| AIRPORT_LONG | Longitude of the | Binary | 4 bytes |
| | airport | | |
| AIRPORT_CITY | Common name of | Text | 32 chars |
| | airport city (e.g. | | |
| | “Atlanta”) | | |
| AIRPORT_STATE | Two-letter | Text | 2 chars |
| | abbreviation of | | |
| | the airport state | | |
| | (e.g. “GA”) | | |
| AIRPORT_COUNTRY | Name of airport | Text | 16 chars |
| | country (e.g. “USA”) | | |
| AIRPORT_NAME | Name of Airport (e.g. | Text | 80 chars |
| | “Hartsfield-Jackson | | |
| | Atlanta International | | |
| | Airport”) | | |
| AIRPORT_ADR_STREET | Airport Address - | Text | 32 chars |
| | Street | | |
| AIRPORT_ADR_CITY | Airport Address - City | Text | 32 chars |
| AIRPORT_ADR_STATE | Airport Address - | Text | 2 chars |
| | (e.g., US State or | | |
| | Canadian Province | | |
| | Abbreviation) | | |
| AIRPORT_ADR_ZIP | Airport Address - Zip | Text | 6 chars |
| | Code (e.g., 5 digit US | | |
| | Zip Code or 6 | | |
| | character Canadian | | |
| | Province Code) | | |
| AIRPORT_IATA_CODE | Three-letter airport | Text | 3 chars |
| | code assigned by | | |
| | IATA (e.g. “ATL”) | | |

In some embodiments, the AIRPORT_POI_ID field of Table 8 can be used for associating reported airports directly to POI's within a mapping database. This can allow for, for example, accurate navigation to the airport by a navigation system. In some embodiments, these direct POI associations can be omitted from the Flight Status service (e.g., and the Flight Status service can use only the latitude/longitude positioning maintained in AIRPORT_LAT and AIRPORT_LONG). Omitting the POI associations can, for example, provide time and effort savings that may otherwise be required to establish POI associations that are acceptable for all involved map database vendors and navigation equipment providers.

In some embodiments, an Airline Database, Airport Database, or both, can be integrated with the HMI at the time the Flight Status service capable-product is shipped. This may, for example, reduce the amount of over-the-air content needed to keep databases accurate. This may be beneficial in a scenario when the databases do not frequently change their content.

An exemplary Flights Schedule Database is shown in Table 9.

TABLE 9
Flights Schedule Database

| | | | Max |
|---|---|---|---|
| Attribute | Description | Format | Length |
| FLIGHT_XMA_ID | Identifier for the flight, | Integer | 2 bytes |
| | used in Flights | | |
| | Status Messages | | |
| | (e.g., can include values | | |
| | from 1 to 40,000) | | |
| FLIGHT_NUM | 1 to 4 digit numeric code | Integer | 2 bytes |
| | assigned by the IATA for | | (14 |
| | this flight (e.g. “57”) (e.g., | | active |
| | can include values from 1 | | bits) |
| | to 9999) | | |
| AIRPORT_DEPART | AIRPORT_XMA_ID of | Integer | 2 bytes |
| | the flight departure | | (14 |
| | airport. | | active |
| | | | bits) |
| AIRPORT_ARRIVE | AIRPORT_XMA_ID of | Integer | 2 bytes |
| | the flight arrival | | (14 |
| | airport. | | active |
| | | | bits) |
| TIME_DEPART | Scheduled departure time | Binary | 2 bytes |
| | of day (e.g., in UTC with 1 | | |
| | minute resolution) | | |
| DAYS_DEPART | Days of week in which this | Binary | 1 bytes |
| | flight departs at the | | (7 |
| | indicated TIME_DEPART. | | active |
| | (e.g., bit field of 7 bits, for | | bits) |
| | each day of week staring | | |
| | with Sunday.) | | |
| TIME_ARRIVE | Scheduled arrival time of | Binary | 2 bytes |
| | day (e.g., in UTC with 1 | | |
| | minute resolution.) | | |
| DAYS_ARRIVE | Days of week in which this | Binary | 1 bytes |
| | flight arrives at the | | (7 |
| | indicated TIME_ARRIVE. | | active |
| | (e.g., bit field of 7 bits, for | | bits) |
| | each day of week starting | | |
| | with Sunday.) | | |
| AIRLINE_OPERATOR | AIRLINE_XMA_ID of | Binary | 1 byte |
| | the primary airline | | |
| | operating this flight | | |

In some embodiments, a Base Date can be provided with each Flights Schedule Database update. The Base Date can indicate the calendar date corresponding to an appropriate baseline (e.g., the first Sunday covered by the database update). Flights Schedule Messages can provide updates to this table periodically (e.g., every two weeks). In this manner, a product can continue to use the previously received schedule while simultaneously receiving an update to the schedules in the background.

In some embodiments, each separate flight segment (e.g., departure/arrival) can include a separate record in the Flights Schedule Database. In some embodiments, this can occur even in the scenario when multiple segments share the same flight number. In this case, if a flight is scheduled for the same depart/arrival times for multiple days of the week, this flight can occurs once in the database. As another example, if the same flight operates at different departure and/or arrival times at different days of the week, the database can contain separate records for this flight for each unique operating time.

An exemplary Flights Codeshare Database is shown in Table 10.

TABLE 10
Flights Codeshare Database

| Attribute | Description | Format | Max Length |
|---|---|---|---|
| CODESHARE_AIRLINE | AIRLINE_XMA_ID of an | Binary | 1 byte |
| | airline code- | | |
| | sharing a flight | | |
| | operated by a primary | | |
| | airline | | |
| CODESHARE_FLIGHT | FLIGHT_XMA_ID | Integer | 2 bytes |
| | identifying the | | |
| | codeshared flight. | | |
| | (e.g., can include | | |
| | values from | | |
| | 1 to 40,000) | | |
| CODESHARE_FLIGHT_NUM | 1 to 4 digit numeric | Integer | 2 bytes |
| | code assigned by the | | (14 |
| | IATA for the | | active |
| | codeshare for this | | bits) |
| | flight. (e.g., can | | |
| | include values from 1 | | |
| | to 9999) | | |

An exemplary Flights Service Banner Database is shown in Table 11.

TABLE 11
Flights Service Banner Database

| | | | Max |
|---|---|---|---|
| Attribute | Description | Format | Length |
| BANNER_CODE | Index for the | Integer | 1 byte |
| | banner. | 0-255 | |
| BANNER_NAME | Text for the banner | Text | 32 chars |
| BANNER_LOGO_SMALL | Small thumbnail | PNG | Variable |
| | (e.g., PNG format) | | |
| | for display of a logo | | |
| | or service symbol | | |
| | with the banner | | |
| | text. | | |
| BANNER_LOGO_LARGE | Larger thumbnail | PNG | Variable |
| | (e.g., PNG format) | | |
| | for display of a logo | | |
| | or service symbol | | |
| | with the banner | | |
| | text. | | |

The service banner data can include a set of text and logos for display as a service banner. In some embodiments, the display of the service banner can be optional. The banner can be used to, for example, display a title of the service, display a sponsor name (e.g. “Acme Flight Report”) to defray the cost of the service, or both. In some embodiments, support for multiple banner records can be provided to allow for different banners to be used for different classes of products, different manufacturers, different OEMs, and the like.

Although exemplary databases with particular values were illustrated in Tables 7-11, one skilled in the art could appreciate that any suitable database could alternatively or additionally be used and that these databases are provided for the purpose of illustration and not as a limitation. For example, values in the database such as the format (e.g., integer, text, PNG, and the like) and max length can include any suitable values. As another example, any suitable attribute name can be used to describe the value.

As mentioned above, in addition to a Flights Database, in some embodiments the Flight Status service can include Flights Schedule Messages, Flights Status Messages, and Flight Delays Messages.

A Flights Schedule Message can include an over-the-air message providing updates to the Flight Schedule Database, Codebase Database, or any other suitable database. In some embodiments, the Flight Schedule Message can be provided on a regular basis (e.g., weekly). The Flight Schedule Message can moreover include incremental or differential updates to the Airline Database and Airport Database.

In some embodiments, incremental updates can be made to the Flights Schedule Database and Codeshare Database. Additionally or alternatively, the Flights Schedule Message can be used in some embodiments as a replacement to incremental updates (e.g., changed records against the Baseline databases) for the Airline Database, Airport Database, and Service Banner Database. The Schedule Message can include Update Files encoded with, for example, a service such as Reliable File Delivery (RFD).

In some embodiments, Flights Schedule Messages can be sent in cycles (e.g., two-week cycles). For example, an update can be sent continuously over two weeks, then a new update is sent over the next two weeks, and so on. In some embodiments, the size of an Update File after reconstruction (e.g., by using a decoder) can be up to 3 Megabytes. In some embodiments, the size can range from 1 to 2 Megabytes.

The protocol for the Flights Schedule Messages can allow for extensibility without affecting earlier Flight Status service product implementations. For example, a Flight Status service may add additional fields in one of the Flights Databases (e.g. concourse or gate information), and the protocol for the Flights Schedule Messages can likewise extended to support update of these new fields. Alternatively or additionally, the Flights Status service can ignore the new fields and continue to process known fields as normal.

A Flights Status Message can include an over-the-air message containing current flight arrival/departure status and times for one or more flights in the Flights Schedule Database that scheduled to arrive or depart within particular period of time (e.g., within 2 hours after the current time), and arrival/departure confirmation of flights that have arrived or departed within a particular period of time (e.g., within 30 minutes preceding the current time). The Flights Status Message can include average departure and arrival delays for one or more tracked airports. In some embodiments, this data can be transmitted relatively frequently. This may advantageously allow a product to always have the latest status within a few minutes of powering on and as status changes.

An exemplary Flights Status Message Database is shown in Table 12. A Flights Status Message can deliver, for example, near real-time updates to flight arrival/departure status with the logical contents described in Table 12.

TABLE 12
Flights Status Message Database (Flight Records Fields)

| Attribute | Description | Format | Length |
|---|---|---|---|
| FLIGHT_STATUS_ID | FLIGHT_XMA_ID that | Integer | 2 bytes |
| | can identify the | | |
| | particular flight | | |
| | reported by this record. | | |
| DELTA_TIME | An Integer (e.g., from 0 | Binary | 7 bits |
| | to 127) that can include | | |
| | the following bitfield | | |
| | encoding: b0:b4 - | | |
| | DTIME value, 0 to 31; | | |
| | and b5:b6 - DTIME | | |
| | An interpretation of these | | |
| | fields can include: | | |
| | 00 - Flight arrival or | | |
| | departure showing delay | | |
| | of DTIME minutes | | |
| | compared to | | |
| | scheduled time; | | |
| | 01 - Flight arrival or | | |
| | departure showing delay | | |
| | of (e.g., [(DTIME × 5) + | | |
| | 30]) minutes | | |
| | compared to | | |
| | scheduled time, where | | |
| | DTIME = 31 can mean | | |
| | “more than 2 hours”; | | |
| | 10 - Flight arrival or | | |
| | departure occurring or | | |
| | occurred DTIME minutes | | |
| | before scheduled time, | | |
| | where DTIME = 31 can | | |
| | mean “more than 30 | | |
| | minutes”; | | |
| | 11 - Value of DTIME | | |
| | indicates special status: | | |
| | 0 - No information | | |
| | available | | |
| | 1 - Flight canceled | | |
| | 2 - Flight Re-routed | | |
| | 3 - Flight delayed, no | | |
| | time estimate | | |
| | available 4 - Flight | | |
| | schedule change, | | |
| | no further | | |
| | information available | | |
| | 4-31 -- RFU | | |
| ARRIVED_DEPARTED | Can indicates if the flight | Boolean | 1 bit |
| | has departed or arrived, | | |
| | where time of | | |
| | departure/arrival can be | | |
| | indicated by | | |
| | DELTA_TIME | | |

In some embodiments, one or more policies can be used to determine which flights receive records in currently transmitting Status Messages. As an example, one policy can include a policy in which only flights with departures or arrivals within a particular window (e.g., within 30 minutes preceding the current time to 2 hours after the current time) can be considered for transmission. This can be referred to as the Active Flight Window. As another example, another policy can include a policy in which future departures/arrivals with reported departure/arrival time that are the same as the times in the Flights Schedule Database are not included in the Status Messages. In this case, the Flight Status service-capable product can assume unreported flights within a period of time (e.g., the next two hours) are reported as “on schedule” by the airlines. Another policy can determine that once a flight arrives or departs, this arrival or departure is reported in the Status Messages as arrived or departed, respectively, with the associated time compared to the scheduled time for a period of time (e.g., 30 minutes) after the actual arrival or departure time. This policy may, for example, be enacted even if the flight has arrived on schedule. As yet another example, a policy can determine that if the scheduled time for a flight is known to be incorrect in the latest Flights Schedule Database update, a record can be included for the flight when in the Active Flight Window that indicates a message such as, “Flight schedule change, no further information available.”

Each Status Message can contain a block of flight records (e.g., stored in Table 12), that can include one or more Status Messages sent to form a complete “cycle” of flight updates. Each Status Message can contain a sequence number such that the product can determine if and when a complete cycle has been received. In some embodiments, if a complete cycle is received and a flight within the Active Flight Window is not reported, the product can assume the flight is on time. In some embodiments, if a complete cycle is not received (e.g., a sequence number is skipped) the product may not determine whether a non-reported flight is, for example, on time or missing. Accordingly, in some embodiments, if a flight is non-reported and a complete cycle is not received for 10 minutes, the Flight Status service-capable product can report a flight status such as “Not Available.”

A header can be included in each Status Message. This header may, for example, include the Base Dates for the latest referenced Flights Schedule Databases, flags that indicate if the flight records in this Status Message did not change since the previous Flights Schedule Database updates (e.g., the previous one updates, previous two updates, or any other suitable number of previous updates), or both. Setting all flags can indicate that flight records in this Status Message are correct when applied against either the current Flights Schedule Database, two or more earlier databases (e.g., spanning 6 weeks of updates, or spanning any other suitable period of updates). In some embodiments, Status Messages can include only the Base Date of the most recent Flights Schedule Database and none of the flags set for previous databases if there has been a schedule change since the previous database update. If the Flight Status service-capable product does not currently have a Flights Schedule Database in storage that matches one of these referenced updates, in some cases it may be unable to depend on the time offsets in that particular Status Message to calculate an absolute arrival or departure time. Accordingly, in this case, in some embodiments the Flight Status service can report a delay (e.g., “Delayed 10 minutes.”

In this manner, the protocol for the Flights Status Messages can allow for extensibility without affecting early Flights Status service-capable product implementations. For example, in some embodiments, the Flights Status service may add additional fields in the Flights Status Messages. In some embodiments, the Flights Status service may ignore these new fields and may continue to process known fields without any issue.

As mentioned above, in addition to Flights Database, Flights Schedule Messages, and Flights Status Messages, in some embodiments the Flight Status service can include Flight Delays Messages. A Flights Delays Message can include an over-the-air message containing average departure and arrival flight delays for one or more airports. In some embodiments, this data can be transmitted relatively frequently, thereby allowing a product to have the latest status within a few minutes of powering on and as status changes. In this manner, the Flights Delays Messages can deliver near real-time updates to airport delays for one or more major airports. The Flight Delays Messages can include the logical contents described below in Table 13.

TABLE 13
Flight Delays Messages Database (Airport Delays Message
Record)

| Attribute | Description | Format | Length |
|---|---|---|---|
| AIRPORT_DELAY_ID | Can represent the | Integer | 2 bytes |
| | AIRPORT_XMA_ID of | | (14 |
| | the reported airport. | | active |
| | | | bits) |
| DEPART_DELAY_TIME | Integer (e.g., from 0 to | Binary | 7 bits |
| | 127) with following | | |
| | bitfield encoding: | | |
| | b0:b4 - DTIME value, 0 | | |
| | to 31; | | |
| | b5:b6 - DTIME | | |
| | An interpretation of these | | |
| | fields can include: | | |
| | 00 - Average Departure | | |
| | Delay equal to DTIME | | |
| | minutes; | | |
| | 01 - Average Departure | | |
| | Delay of | | |
| | [(DTIME × 5) + 30] | | |
| | minutes with DTIME = | | |
| | 31 meaning “more | | |
| | than 2 hours”; | | |
| | 10 - RFU; and | | |
| | 11 - Value of DTIME | | |
| | indicates special status: | | |
| | 0 - No information | | |
| | available | | |
| | 1 - Airport closed for | | |
| | departures | | |
| | 2-31 - RFU | | |
| ARRIVE_DELAY_TIME | Integer (e.g., from 0 to | Binary | 7 bits |
| | 127) that can include the | | |
| | following bitfield | | |
| | encoding: b0:b4 - | | |
| | DTIME value, 0 to | | |
| | 31; and | | |
| | b5:b6 - DTIME | | |
| | An interpretation of these | | |
| | fields can include: | | |
| | 00 - Average Arrival | | |
| | Delay equal to DTIME | | |
| | minutes; | | |
| | 01 - Average Arrival | | |
| | Delay of | | |
| | [(DTIME × 5) + 30] | | |
| | minutes with DTIME = | | |
| | 31 meaning “more | | |
| | than 2 hours”; | | |
| | 10 - RFU; and | | |
| | 11 - Value of DTIME | | |
| | indicates special status: | | |
| | 0 - No information | | |
| | available | | |
| | 1 - Airport closed to | | |
| | arrivals | | |
| | 2-31 -- RFU | | |

Although exemplary databases with particular values were illustrated in Tables 12 and 13, one skilled in the art could appreciate that any suitable database could alternatively or additionally be used and that these databases are provided for the purpose of illustration and not as a limitation. For example, values in the database such as the format (e.g., binary, integer, and the like) and length can include any suitable values. As another example, any suitable attribute name can be used to describe the value.

As mentioned above, the Flight Status service can provide a user with flight status monitoring. In some embodiments, one or more methods can be provided to allow a user to select a particular flight for status monitoring.

As an example, one method can allow a user to select a particular flight for status monitoring through the flight number. In this scenario, a user can, for example, first select an airline (e.g., from a list of airlines that may be alphabetically sorted) and enter the flight number (e.g. by using a physical keypad, a virtual keypad on a touchscreen, soft keys, preset buttons, or by using any other suitable input device). In some embodiments, a flight can be identified based on this information (e.g., since the selection of specific status records can be based on the flights inclusion in the Active Flight Window). As used herein, the term “Active Flight Window” can refer flights arriving or departing within a particular period of time (e.g., within 30 minutes of the current time to two hours after the current time). In some embodiments, to completely identify the flight, a user can additionally or alternatively select an airport and/or arrival/departure choice.

As another example, a method can allow a user to select a particular flight for status monitoring by selecting an airline and route. This may, for example, be beneficial when a user is unsure of a Flight number. In this case, a user can select one or more of the airport, arrival/departure, and airline. To select the airport, in some embodiments a full list of available airports can be shown. In some embodiments, the airports nearest the user (e.g., determined based on a GPS location) can be shown at the top of the list. When selecting an airline, in some embodiments the user can be presented with an airline list that is abridged to show only airlines serving the selected airport, abridged departing or arriving during the current Active Flight Window, abridged in any other suitable manner, or any combination of the above. In response to selecting the suitable items, a list of flights matching the airline and arriving or departing at the selected airport can be provided to the user. For example, matching flights within a window of 2 hours, matching flights sorted in time order, or both can be provided. From this list, the user can select a flight of interest.

As yet another example, a method can allow a user to select a particular flight for status monitoring by selecting a particular route. This may, for example, be beneficial when a user is uncertain of the flight number, airline, or both. In this scenario, a user can select one or more of the airport and arrival (e.g., originating point of the flight) or departure (e.g., destination airport of the flight). To select the airport, in some embodiments a full list of available airports can be shown. In some embodiments, the airports nearest the user (e.g., determined based on a GPS location) can be shown at the top of the list. When a departure is selected, in some embodiments the list can be reduced to include only other airport endpoints for flights that serve the selected airport and are scheduled during the current Active Flight Window. In response to selecting the suitable items, a list of flights (e.g., of any suitable airline) matching the route and origination/destination can be provided to the user. For example, matching flights within a window of 2 hours, matching flights sorted in time order, or both can be provided. From this list, the user can select a flight of interest.

In some embodiments, in addition to providing these methods selecting a flight for status monitoring, the Flight Status service-capable product can provide a “favorites” feature. For example, the favorites feature can allow a user to reduce the depth of various search lists by pre-selecting favorites for airports and/or airlines.

In some embodiments, the Flight Status service-capable product can display the current status of a selected flight once it is selected. In some embodiments, statuses can be shown on,as a single line on a display (e.g., while a vehicle is being driven).

Delay information of a flight of interest can be provided to a user in any suitable manner. For example, in response to a flight being delayed, the delay time can be shown (e.g., “DL 1234 Delayed 15 min”). As another example, additional information regarding the schedule can be displayed (e.g., “DL 1234 Delayed 15 min. Updated Departure: 3:50 pm”). In some embodiments, in response to a flight departing or arriving from an airport covered by delay reporting, delay reporting information can be shown (e.g., “DL 1234 Delayed 15 min. Updated Departure: 3:50 pm Average Airport Departure Delay: 30 minutes”). Additionally or alternatively, any other suitable status advisories can be delayed such as, for example, “DL 1234 Canceled,” “DL 1234 Delayed (Estimate Unavailable),” “DL 1234 No Status Information Available,” “DL 1234 Arrival Re-routed,” “DL 1234 Schedule Changed (Details Unavailable)” or any other suitable status advisories.

In some embodiments, a Flight Status service-capable product may additionally or alternatively offer navigation to the airport for the selected flight. For example, the latitude/longitude data, POI reference, or both in the Airport Database can be passed to the navigation system for trip routing. In some embodiments, a Flight Status service-capable product may additionally or alternatively offer to display the phone number of an airline to a user. This may, for example, be beneficial in a system including a phone interface (e.g., a Bluetooth™ interface or other wireless or wired interface) when a user wants to talk to the airline (e.g., regarding additional details such as a delay, a need to rebook a flight, or other suitable details). In some embodiments, logos may be displayed for airlines in, for example, various lists and advisories.

In some embodiments, the Flight Status service can nominally support 30,000 flight schedules, up to maximum of 40,000 flight schedules, or any other suitable number of flight schedules. In some embodiments, the Flight Status service can nominally support 5,000 flights in an Active windows, up to maximum of 7,000 flights, or any other suitable number of flights in an Active windows. In some embodiments, the Flight Status service can nominally support 35 average airport delays for airports, up to maximum of 100 delays, or any other suitable number of delays. In some embodiments, the Flight Status service can nominally support 120 airlines, up to maximum of 200 airlines, or any other suitable number of airlines. In some embodiments, the Flight Status service can nominally support 5,000 airports, up to maximum of 10,000 airports, or any other suitable number of airports.

In some embodiments, the Flights service data can transmitted over a data SID and can use a bandwidth of 4 kilobytes per second (“kbps”). In some embodiment the 4 kbps can be allocated such that approximately 3 kbps is used for transmission of Flights Schedule Messages (i.e., RFD encoded database updates). This bandwidth may, for example, support reception of schedule updates with cumulative reception of about 30 minutes to 1 hour over a two week period. The 4 kbps bandwidth can also be allocated such that approximately 1 kbps is used for transmission of Flights Status Messages and the Flights Airport Delays Message. This may, for example, result in a cycle time for a complete update of flights in the current Active Flights Window of roughly 2 to 3 minutes.

A Flight Status service-capable product can include a number of modules for supporting the Flight Status Service. For example, modules such as a receiver module, electrical connections, non-volatile storage, other storage, Reliable File Delivery decoder software, GPS resources, navigations subsystems, HMI processing capability, or any other suitable module can be included

In some embodiments, the Flight Status service-capable product can include an SDARS receiver module.

In some embodiments, the Flight Status service-capable product can include one or more electrical connections between the receiver chipset or module and the Flight product's controller for a low-speed data port (LSDP) or high-speed data port (HSDP). This connection can convey the transmitted Flights data from the receiver to the products HMI for processing and storage.

In some embodiments, the Flight Status service-capable product can include a non-volatile storage (e.g. flash drive, hard drive, or the like) to maintain a databases such as the database shown in Table 14.

TABLE 14

| | Nominal | |
|---|---|---|
| Database | Storage | Maximum Storage |
| Airport Database | 1.0 MByte | 2.2 MBytes |
| Airline Database | 0.6 MBytes | 1.2 MBytes |
| Flights Schedule | 0.5 MBytes | 0.7 MBytes |
| Database | | |
| Codeshare Database | 0.3 MBytes | 0.4 MBytes |

In some embodiments, the Flight Status service-capable product can include storage (e.g. RAM, flash, or hard drive) to maintain the latest Flights Status and Airport Delays data received over the air (e.g., approximately 15 kb to 22 kb).

In some embodiments, the Flight Status service-capable product can include RFD decoder software. This software can be used in the HMI to reconstruct Flights Airline Database Update Files from data cumulatively received over the air and can include any sufficient amount RAM resources to decode the file (e.g., a file size of maximum 3 Mb, or any other suitable size).

In some embodiments, the Flight Status service-capable product can include GPS resources (e.g., to determine the current vehicle location relative to airport locations), a navigation subsystem (e.g., capable of accepting the location of a user-selected airport for trip routing), or both.

In some embodiments, the Flight Status service-capable product can include sufficient HMI processing capability to parse data received from the receiver data port, store received flights Status Messages in local HMI memory, respond to user interactions to identify flights and select them for monitoring, accumulate incrementally received packets for Flights Airline Database Updates and when sufficient packets are received, execute the RFD decoder to reconstruct a full Database Update File, or any combination of the above.

Next described are Fuel Data Services according to an exemplary embodiment of the present invention.

### III. Fuel Data Services

In yet other embodiments, systems and methods are provided for providing fueling services, such as information on fueling stations and the prices and fuel types available at the fueling stations.

Table 15 (below) may provide definitions used throughout this disclosure, at least with respect to fuel data services. It should be understood that any examples provided in the definitions are merely illustrative and not intended to limit embodiments of the invention to the examples.

TABLE 15
Glossary (Fuel Data Service)

| Term | Definition |
|---|---|
| 0x | A prefix that may indicate a hexadecimal number. |
| Aftermarket | An “Aftermarket” radio may refer to any radio that is not |
| | factory installed in a vehicle, and therefore can include a |
| | wide range of products including but not limited to |
| | portables, plug & play radios, home radios, and retail- |
| | installed automotive head units. (See also the definition |
| | for OEM.) |
| Application | Messages for all data services may be wrapped in |
| ID | packets referred to as Application Packets. These |
| | packets may each begin with a header that includes an |
| | “Application ID” to identify the type of message within |
| | the packet. In this manner, different messages (and |
| | even different data services) can be interleaved on the |
| | same channel (SID), with the Application IDs used to |
| | distinguish them on reception by the product's data |
| | parsing software. |
| Authorized | A channel may be “authorized” for a radio if the radio |
| | has been provided (through over the air signaling or |
| | special factory activation) with authorization to decrypt |
| | and play that channel. |
| Best | A set of recommendations and guidelines, which may be |
| Practices | for a product user interface, which may communicate the |
| | “best practices” for implementing a service in a product |
| | to the product developer community. |
| Data Service | A “Data Service” may involve transmission of data |
| | instead of live audio over the system; for example a |
| | traffic data service (e.g., NavTraffic), a weather data |
| | service (e.g., WX Weather), stock tickers, sports scores, |
| | or channel graphics updates. |
| Data SID | The Service ID (channel) over which a Data Service may |
| | be transmitted. |
| Reliable File | A data encoding, transmission, and decoding method |
| Delivery | where a binary file may be transmitted as a stream of |
| | blocks which may be over time accumulated by a |
| | product. Once a sufficient number of blocks are |
| | accumulated by the product (which may be a cumulative |
| | size a few percent larger than the original binary file |
| | size), the product HMI can execute Reliable File Delivery |
| | decoder software to reconstruct the original binary file. |
| | This method may have the advantage that the product |
| | can gradually accumulate any of the streamed blocks |
| | over a long duration: days, weeks or even months. It |
| | may be particularly useful for transmitting database |
| | update files to a group of products. |
| HMI | Human-Machine Interface. This can include software |
| | that runs the service, controls a receiver, and/or |
| | presents the UI to the user. |
| OEM | OEM may refer to an “automotive OEM.” An OEM radio |
| | may be any radio that is factory installed in a vehicle. |
| | (See also the definition for Aftermarket.) |
| OTA | Over The Air |
| Plug and | A class of aftermarket radio that may be installed in a |
| Play | vehicle by the end user, which may be attached to the |
| | outside of the dash area. |
| PND | Personal Navigation Device |
| POI | Point Of Interest. A POI may refer to an object (such as |
| | a parking garage, gas station, or business) modeled in a |
| | navigation mapping system, with known location relative |
| | to navigable roads or other landmarks in the mapping |
| | system, and potentially other attributes such as name, |
| | address, phone number, etc. |
| Product | A product may be a system that incorporates |
| | functionality described in this document. Examples |
| | include an automotive head unit, an automotive |
| | navigation system that interfaces with a receiver module, |
| | a “plug and play” aftermarket radio, or a Personal |
| | Navigation Device (PND). |
| Protocol | A technical specification of the data format that may be |
| | used to transmit the fueling data or other data service |
| | over the air. |
| Recommen- | Specifies an operation that is optional, but not required. |
| dation | Reserved for Future Use. Product may ignore the value |
| RFU | of any field marked as RFU. |
| RUDE | A RUDE (Radio User Digital Entitlement) Word may |
| Word | refer to a bit field within the receiver chipset that can be |
| | securely changed for individual receivers by signals sent |
| | over the air by the service. It may be used to authorize |
| | certain extended radio capabilities (such as Fueling |
| | services discussed herein). Effectively, RUDE words |
| | may provide auxiliary “authorization flags” that can be |
| | read by HMI software to determine service authorization |
| | levels. |
| SID | Service ID. The number assigned to a channel that may |
| | not be visible to the user, which in some embodiments |
| | may take on a value from 0 to 255. Each channel can |
| | be assigned a Channel Number and a SID. The SID for |
| | a channel might change rarely, whereas the |
| | corresponding Channel Number for a channel may be |
| | changed from time to time. |
| Track | Track may refer to the direction of vehicle travel. “Track |
| | Forward” may refer to the same direction of current |
| | vehicle travel, and “Track Backward” may refer to the |
| | opposite direction of current vehicle travel. |
| Truck Stop | A type of fueling or gas station that may service the |
| | needs of large commercial transport trucks. |
| Type | A suite of tests that may be run by the developer or |
| Approval | another person, system, or service to verify compliance |
| | with Minimum Features and Functionality. |
| UI | User Interface |

In some embodiments, a Fuel Service may be provided. The Fuel Service can provide near real-time updates to the fuel prices for fuel or gas stations in a suitable geographic area (e.g., the continental US, the continental US and Canada, etc.). The Fuel Service may be used, for example, by a car driver wishing to find a nearby station with a particular brand of fuel at a particular price.

The Fuel Service may provide fueling information as a “data service” (i.e., data conveyed over a data channel to a receiver). Software in the receiving product, which may be referred to sometimes as the “HMI”, may be responsible for interpreting this data and presenting it to the user through a user interface (“UI”).

The Fuel Service may be provided to products that incorporate a navigation system. Such systems may not only display a list of nearby fueling stations and available brands and prices, but may also offer the capability for the user to navigate to a chosen fueling station. However, the Fuel Service can also be used by a product without a navigation system or even a GPS. In these embodiments, the Product, for example, may list nearby or favorite fueling stations and fuel prices and brands available.

In some embodiments, providing the Fuel Service can involve obtaining fuel price and brand availability updates (e.g., from third party data providers), obtaining fuel station information (e.g., addresses, phone numbers, geographic location, brand, total available spaces, etc.) from one or more data providers (e.g., from third party data providers), generating or creating a database of fuel station information (e.g., creating a baseline database for individual development), transmission over systems of updates to fuel prices and available brands, transmission over systems of updates to the database of fuel station information, and provisioning (e.g., authorization and billing) for the Fuel Service, or any combination thereof.

In some embodiments, the system for providing a Fuel Service can involve a variety of components, including but not limited to a Fuel Server, a Fuel Console, a Fuel Protocol, a Fuel UI, and Fuel Provisioning. The Fuel Server may be maintained by broadcast operations for ingesting fuel and gas station source data from third party or any other suitable sources, and may format the data for transmission over the air. The Fuel Server can include hardware and software similar to servers already in use for other types of data services.

The Fuel Console may include a software application used by broadcast operations to compile, edit, and attribute the ingested Fuel Server data. A portion of the data flowing through the Fuel Server may be processed automatically. Some administrative services, such as compiling updates to gas station databases and controlling relative bandwidth allocated for gas station database updates versus fuel price and brand availability updates can be controlled through the Fuel Console application.

The Fuel Protocol can include a technical specification for the format of the Fuel data as transmitted over the air to Fuel Service-capable products. This specification may be used by developers incorporating Fuel Service capability in their product design.

The Fuel UI may include a user interface implemented by the Fuel Service-capable product, and may be used to present Fuel-related data to an end user (e.g., car driver). The UI may or may not vary greatly from product to product. For example, in some embodiments, the Fuel UI for a simple Plug and Play Aftermarket device with limited lines of display and memory may be different from the Fuel UI for an OEM navigation system incorporating a large touchscreen and hard drive for storage.

The Fuel Provisioning may include business system procedures and policies used to authorize use of the Fuel Service for specific radios, bill the customer for the services, or any other suitable business-related activities or needs.

The Fuel Service can provide a variety of different information to aid a user in identifying a gas station at which to fuel his or her vehicle. For example, in some scenarios, a user of a Fuel Service-enabled product may be unfamiliar with a city, and may therefore be unaware of where he or she can get fuel. In these scenarios, responsive to a request by the user, the Fuel Service can provide a display of fuel station icons on a navigation display. In some embodiments, the Fuel Service may display the icons on a navigation map, such that the user may discern the relative locations of the stations with respect to the current position of the user. The user may select a particular station, and the Fuel Service may then provide more information about the selected station, such as available brands of fuel at that station, the prices of those brands, and the directions to and operational hours of the selected station. This way, the Fuel Service may provide information on one or more stations, allowing the user to be confident in the direction he or she is heading in an unfamiliar area.

In some embodiments, a Fuel Service may indicate the availability of fuel at stations near a user's current location or a selected destination. Automatically or in responsive to a request by the user, the Fuel Service can provide a list or other visual display of the stations in the area of interest. The display may visually indicate which stations include available brands of fuel and the current prices of those brands. For example, stations that are running low or have no fuel for one or more brands may be highlighted in red while stations that have ample supply of one or more brands may be highlighted in green. One or more symbols, such as a dollar sign “$” may be provided to indicate the relative price of each available brand, or a currency value may be indicated next to each brand. This way, the user can quickly and easily identify which station to drive towards. It should be understood that the Fuel UI can use any other suitable technique for visually distinguishing stations with available fuel brands at various prices from those without or substantially without available fuel brands at various prices, such as using bolding, color, size, or font of text or using different icons, for example.

In some scenarios, a user of a Fuel Service-enabled product may want to locate a place to obtain fuel that is cheap. Responsive to a user request, the Fuel Service may provide pricing information for stations near the user's current location or selected destination and may provide information on how far away each station is from the location and the current prices for the brands of fuel available at each station. This way, the user can balance how much he or she is willing to spend with respect to distance. For example, the Fuel Service may enable a user to identify a station farther away that might be considerably cheaper for the brand of fuel that the user may want.

In some embodiments, the user may configure a Fuel Service to list current fuel station information based on distance to a selected location, or based on any other suitable variable, such as price, available fuel brands, hours of operation, and the like. For example, the Fuel Service may list an initial number (e.g., five) of the closest stations to the selected location in an order based on the price of one or more available brands at those stations. If that initial listing does not include a station offering fuel at a suitable price to the user, the Fuel Service may allow the user to select an expand option (e.g., by providing a selectable “EXPAND” button), such that a list of additional stations may be presented to the user that might offer a suitable price.

In some scenarios, responsive to a user request or automatically, the Fuel Service may provide data on the various brands and types of fuel available at various stations. Brands may include the type of fuel provider (e.g., Citgo™, Exxon™, etc.), the type of fuel provided (e.g., diesel, regular unleaded, premium, hydrogen (e.g., for fuel cell vehicles), etc.), and the like. In some embodiments, the Fuel Service may automatically or at the user's selection only provide data on certain brands and types of fuel based on the needs of the particular user and the needs of his or her particular vehicle. In this way, if the user needs a particular type of fuel (i.e., fluid, gas or electricity for propelling a vehicle) or would only like to support one or more certain fuel providers, the user can more easily determine which station or stations may be useful.

In some scenarios, responsive to a user request, for example, the Fuel Service may provide data on the hours of operation of stations near is the user's selected location. In this way, if the user needs fuel at an off-peak hour (e.g., 3 AM), the user can determine which station or stations may be open.

In some scenarios, responsive to a user request, for example, the Fuel Service may provide data on the availability of one or more types of fuel at stations near the user's selected location. In this way, if there is a fuel shortage, the user can determine which station or stations may currently have the fuel he or she needs.

In some embodiments, the Fuel Service may provide instructions on how to reach a particular station. For example, the Fuel Service may provide a display indicating which stations are open and have suitable fuel, and may allow user to select a particular station (e.g., by providing a selectable “GO” button). Responsive to receiving the user selection, the Fuel Service may place the car's navigation system into a routing mode and may provide the user with guidance (e.g., turn-by-turn guidance) to the selected station. This way, the user may easily navigate through unfamiliar or difficult-to-navigate areas.

In some embodiments, the Fuel Service may allow a user to select and save a list of “preferred fuel stations.” The list may include, for example, stations that the user commonly uses (e.g., near a work location or along a commonly driven route). The Fuel Service may display information about the stations in the list upon request, such as available fuel brands and current prices at those stations.

In some embodiments, the Fuel Service may allow a user to select and save settings for a “fuel alert” mode. The settings may include, for example, one or more acceptable fuel brands, a threshold distance from a certain location (e.g., a user's current location), a threshold for price, and a threshold for current fuel level of the user's vehicle. When in a “fuel alert” mode, for example, the Fuel Service may automatically provide an alert to the user when his or her vehicle's current fuel level is below the set fuel level threshold, and may provide data on the availability of the mode's set acceptable fuel brands, within the set threshold distance, and under the set threshold price. In this way, the user may be automatically provided with helpful Fuel Service data when he or she needs it most.

In some embodiments, the Fuel Service may provide a “fuel emergency” mode. When in a “fuel emergency” mode, for example, the Fuel Service may automatically provide an alert to the user when his or her vehicle's current fuel level is below a threshold that may depend on the distance of the user from available fuel stations. For example, the Fuel Service may constantly monitor the user's vehicle's fuel level and estimated mileage range before critical fuel level. The Fuel Service may also monitor the location of currently available gas stations (or at least currently available gas stations that meet certain user preferences) along the user's navigation route or within a certain distance of the user's current location. The Fuel System may automatically calculate that if the user passes the closest station without obtaining fuel, the user may be in jeopardy of running out of fuel (e.g., before reaching the next closest station). In such embodiments, the Fuel Service may provide an alert to the user that he or she should get gas at that closest station.

In some embodiments, the Fuel Service may provide a “non-navigation” mode. When in a “non-navigation” mode, for example, the Fuel Service may be used without a navigation service (e.g., GPS), but may still provide the user with information about available fuel stations. For example, the user may provide the service with a zip code or other location information, and the Fuel Service may provide a suitable list of helpful fuel station information within a suitable distance of that zip code, including a list of one or more addresses of one or more fuel stations that may meet one or more user specifications or general specifications, such as available fuel, for example.

The Fuel Service may automatically expand the stations reported to the user. That is, without a specific request by the user, the Fuel Service may maintain up-to-date information on stations and their carried brands and current prices. The. Fuel Service can, for example, add any new stations that may open and may update the brands carried and current prices of those brands for each station, as well as their current hours of operation and any specials or promotions they may be conducting.

As discussed above, the Fuel Service may include a Fuel Protocol that may specify the over-the-air protocol for transmitting Fuel data. To support such a protocol, the Fuel Service may utilize a Fuel Station Database, Fuel Station Database Update Messages, and Fuel Price Messages. The Fuel Station Database may include a database of fuel station attributes (e.g., address, telephone number, location, associated brand or brands, etc.), which may be maintained by the HMI in persistent, updatable storage (e.g., flash or hard drive). A version of this database, referred to sometimes as the Fuel Baseline Station Database, may be shipped with the HMI at the time the product is shipped or as part of a vehicle map update.

As described in greater detail below, the Fuel Station Database Update Message may be an over-the-air message containing updates to the Fuel Baseline Station Database. A product can optionally use this information to update their local copies of the Fuel Station Database with changes, such as new stations, changes in one or more brands for an existing station, changes in current availability of one or more brands for a station, changes in current prices for one or more available brands of a station, and the like. In some embodiments, these changes may be transmitted quarterly using limited bandwidth for background accumulation by the product.

As described in greater detail below, the Fuel Price Message may be an over-the-air message containing current available fuel brands and/or prices for each of the available stations in the Fuel Station Database. In some embodiments, this data may be transmitted relatively frequently, so a product may have the latest space availability within a few minutes of powering on and as space availability changes.

Returning to the Fuel Station Database, the Fuel Station Database may be used to store Fuel Types, Station Brands, Station Data, and Service Banners, or any combination thereof. Tables 16-19, provided below, show illustrative attributes of Fuel Types and Grades, Station Brands, Station Data, and Service Banners, respectively that may be stored in the Fuel Station Database. It should be understood that the attributes provided in these tables are merely illustrative, any additional attributes may be added, and any of the listed attributes may be removed or modified (e.g., use a different storage format, include a different number of bits, bytes, chars, etc., or any other suitable attribute modification).

Table 16 below may illustrate attributes that may be stored for each reported fuel type and grade. The fuel types, for example, may be encoded as a 4-bit integer, as shown in Table 16. Furthermore, each fuel type may be subclassified with a grade (e.g., a 2-bit integer, value 0-3), with grade 0 meaning ungraded (e.g., either not graded or grade unknown), for example.

TABLE 16
Fuel Type Codes

| | | FUEL_GRADE_CODE/ | | | |
|---|---|---|---|---|---|
| | | FUEL_GRADE_DESC | | | |
| FUEL_TYPE_CODE | FUEL_TYPE_DESC | 0 | 1 | 2 | 3 |
| 0 | Gas | (Ungraded) | Regular | Mid- | Premium |
| | | | | grade | |
| 1 | Diesel | (Ungraded) | Regular | RFU | RFU |
| 2 | Biodiesel | (Ungraded) | B2/B5 | B20 | RFU |
| 2 | Ethanol | (Ungraded) | E85 | RFU | RFU |
| 3 | RFU | (Ungraded) | RFU | RFU | RFU |
| | (Hydrogen) | | | | |
| 4 | RFU (Electrical) | (Ungraded) | RFU | RFU | RFU |
| 5-15 | RFU | (Ungraded) | RFU | RFU | RFU |

Common Fuel Station Brands may be maintained in a table in which an integer brand code may be associated with a text name and optionally graphic logos, as illustrated in Table 17 below.

TABLE 17
Brand Codes and Attributes

| | | | Max |
|---|---|---|---|
| Attribute | Description | Format | Length |
| BRAND_CODE | Index for this brand. | Integer | 1 byte |
| | | 0-255 | |
| BRAND_NAME | Name of the brand | Text | 24 chars |
| | (e.g., “BP ™”, | | |
| | “Shell ™”) | | |
| BRAND_LOGO_SMALL | Small PNG thumbnail | PNG | Variable |
| | for brand, which | | |
| | may be useful for | | |
| | a map icon or | | |
| | small color display. | | |
| BRAND_LOGO_LARGE | Larger PNG thumbnail | PNG | Variable |
| | for brand, which may | | |
| | be useful for | | |
| | displaying with a | | |
| | list of stations | | |

Table 18 below may illustrate attributes that may be stored for each reported station.

TABLE 18
Station Data Record

| Attribute | Description | Format | Length |
|---|---|---|---|
| STATION_XMF_ID | Identifier for the station | Integer | 18 bits |
| | used in Fuel Prices and | | |
| | Station Database Update | | |
| | Messages. | | |
| | 1 to 262,143 | | |
| STATION_POI_ID | Optional cross-reference to | Integer | 8 Bytes |
| | a global POI identifier, for | | |
| | associating the station to a | | |
| | POI in a mapping database. | | |
| STATION_LAT | Latitude of the station | Binary | 4 bytes |
| STATION_LONG | Longitude of the station | Binary | 4 bytes |
| STATION_NAME | Common name of station | Text | 32 |
| | (e.g., “BP ™”, “Shell ™”) | | chars |
| STATION_BRAND | Brand of station | Binary | 1 byte |
| | (BRAND_CODE), or 0 if | | |
| | station does not possess a | | |
| | common brand. | | |
| STATION_ADR_STREET | Station Address - Street | Text | 32 |
| | | | chars |
| STATION_ADR_CITY | Station Address - City | Text | 32 chars |
| STATION_ADR_STATE | Station Address - US State | Text | 2 chars |
| | or Canadian Province | | |
| | Abbreviation (or any other | | |
| | appropriate country or | | |
| | regional terminology) | | |
| STATION_ADR_ZIP | Station Zip Code (e.g., 5 | Text | 6 chars |
| | digit US Zip Code or 6 | | |
| | character Canadian | | |
| | Province Code) | | |
| STATION_PHONE | Station Telephone Number | BCD | 10 |
| | | | bytes |
| STATION_FUEL_AVAIL | Fuel Types and Grades | Binary | 8 bytes |
| | available at the station | Array | |
| | (e.g., as an array of 16 4-bit | | |
| | nibbles, where bit m of | | |
| | nibble n may be 1 if | | |
| | FUEL_GRADE_CODE m of | | |
| | FUEL_TYPE_CODE n is | | |
| | normally available at the | | |
| | station). | | |
| STATION_FUEL_PRICING | Fuel Types and Grades | Binary Array | 8 bytes |
| | priced for the station | | |
| | (e.g., as an array of 16 4-bit | | |
| | nibbles, where bit m of | | |
| | nibble n may be 1 if the Fuel | | |
| | Pricing Messages may | | |
| | include pricing for the | | |
| | FUEL_GRADE_CODE m of | | |
| | FUEL_TYPE_CODE n). | | |
| STATION | Special services, which may | Binary | 1 byte |
| SERVICES | be present if a | Array | |
| | corresponding bit is 1, | | |
| | undetermined if bit is 0: | | |
| | b0: Truck Stop | | |
| | b1: Restaurant | | |
| | b2: Convenience Store | | |
| | b3: Repair Services | | |
| | b4: Interstate Access | | |
| | b5: Car Wash | | |
| | b6-b7: RFU | | |
| | (if bn = 1, the corresponding | | |
| | service is available at the | | |
| | garage; if bn = 0, the service | | |
| | may or may not be available at | | |
| | the garage.) | | |

The STATION_POI_ID field may support associating reported gas stations directly to POIs within a mapping database, for more accurate navigation to the station by a navigation system. However, due to the time and effort that may be necessary to establish such map POI associations acceptable for various involved map database vendors and navigation equipment providers, the Fuel Service may be implemented without these direct POI associations. Instead, the Fuel Service may use lat/long positioning maintained in STATION_LAT and STATION_LONG, for example. Thus, the service protocol may be designed to support station positioning using simple lat/long data, or using a more sophisticated reference to a navigation system's POI database, or both (e.g., most stations using POI references, but “new” stations positioned with lat/long data).

Service banner data may include a set of text and logos for optional display as a service banner. The banner can be used as simply a title of the service, or optionally to include a sponsor name (e.g., “Acme Fuel Report”) to defray the cost of the service. In some embodiments, support for multiple banner records can be provided to allow for different banners to be used for different classes of products, different manufacturers, different OEMs, etc. Table 19 below shows the illustrative contents of each banner record.

TABLE 19
Service Banner Records

| | | | Max |
|---|---|---|---|
| Attribute | Description | Format | Length |
| BANNER_CODE | Index for this | Integer | 1 byte |
| | banner. | 0-255 | |
| BANNER_NAME | Text for the banner. | Text | 32 chars |
| BANNER_LOGO_SMALL | Small PNG | PNG | Variable |
| | thumbnail for | | |
| | optional display of | | |
| | a logo or service | | |
| | symbol with the | | |
| | banner text. | | |
| BANNER_LOGO_LARGE | Larger PNG | PNG | Variable |
| | thumbnail for | | |
| | optional display of | | |
| | a logo or service | | |
| | symbol with the | | |
| | banner text. | | |

As discussed above, updates to portions of the Fuel Station Database may be sent in Fuel Station Database Update Messages. These update messages may contain Update Files encoded with Reliable File Delivery. In some embodiments, each record in an Update File may contain the STATION_XMF_ID of the affected station, followed by any changed or added fields. For new stations, the fields described in Table 18 (Station Data Record) may be included in the update record. In some embodiments, for updates to existing stations, only the changed fields may be included in the record. The Fuel Station Database Update Message may also include updates to the Brand Codes, Service Banners, Fuel Type Codes, Fuel Grade Codes, and their associated attributes.

In some embodiments, to conserve product HMI RAM memory that may be used to decode accumulated blocks of an update, the maximum size of an Update File after may be 3 Mbytes. When the number of updates exceeds 3 Mbytes, multiple update files may be transmitted, and each may be separately encoded with Reliable File Delivery.

The protocol for the Fuel Station Database Update Messages may allow for extensibility without affecting earlier Fuel Service product implementations. For example, a future version of the Fuel Service may add additional fields to the Fuel Station Database, and the protocol for the Fuel Station Update Messages may be likewise extended to support update of these new fields. However, older Fuel Service implementations may ignore the new fields and continue to process known fields without any issue.

As discussed above, Fuel Prices Messages may be used to deliver near real-time updates regarding availability and prices of fuel. In some embodiments, the prices of fuel may be provided in accordance with the attributes provided in Table 20 below. The format of the Fuel Prices Message can incorporate various compression techniques to assure this information may utilize minimal bandwidth, and can therefore be retransmitted as quickly as possible within the allocated bandwidth. Table 20 may describe only the logical content of these messages if this data was sent in relatively uncompressed format. Transmission size with compression may use slightly over 1 byte per fuel type/grade reported for the station.

TABLE 20
Fuel Prices Data Elements

| Attribute | Description | Format | Length | |
|---|---|---|---|---|
| STATION_XMF_ID | Identifier for a reported | Integer | 18 | bits |
| | station, linking to the | | | |
| | Station Database. | | | |
| PRICED_FUEL_TYPE | FUEL_TYPE_CODE for the priced | Integer | 4 | bits |
| | fuel | | | |
| PRICED_FUEL_GRADE | FUEL_GRADE_CODE for | Integer | 2 | bits |
| | the priced fuel | | | |
| PRICE_VALUE | Latest reported fuel price | Integer | 12 | bits |
| | for the identified fuel | Cents | | |
| | type/grade for this station | | | |
| | (e.g., in a range of $0.00 to | | | |
| | $40.95) | | | |
| PRICE_AGE | Age of the pricing for each | Binary | 2 | bits |
| | reported fuel type/grade, | | | |
| | with values that may | | | |
| | represent: | | | |
| | * Pricing within 1 day old; | | | |
| | * Pricing within 2 days old; | | | |
| | * Pricing within 3 days old; | | | |
| | and | | | |
| | * Pricing older than 3 days | | | |
| | old. | | | |
| FUEL_SHORTAGE | Indicates if this fuel | Binary | 1 | bit |
| | type/grade normally | | | |
| | available at the station is | | | |
| | not available (e.g., fuel | | | |
| | shortage situation). | | | |

The protocol for the Fuel Prices Messages may allow for extensibility without affecting early Fuel product implementations. For example, a future version of the Fuel Service may add additional fields to the Fuel Prices Messages or may start supporting new fuel types. However, older implementations can ignore the new fields and continue to process known fields without any issue.

The Fuel Service may use any suitable technique or provide any suitable interface for presenting fuel information to a user. In some embodiments, the Product Service may select candidate stations to present to the user, such as in response to a user request to view potential stations to use. The Fuel Service may select stations using any number of suitable factors. Optionally, the selection may be based on GPS proximity. Here, a current vehicle location, which may be provided by a vehicle GPS function (e.g., in a navigation or safety & security system), may be used to locate the closest stations. Optionally, the selection may be based on the navigation route of the user. Here, candidate stations may be located based on their proximity to locations along the navigational route or destination or POI identified through the navigation system. In some embodiments, the selection of candidate stations may be made based on market. For products that may not have access to the vehicle location, a list of candidate stations may be assembled by first selecting a city from a list, then an area of the city (e.g., North, Northeast, East, etc.). For example, this may be implemented using a separate database that associates station zip codes with the market areas.

In addition to the above-described selection mechanisms, the product can offer additional filtering of candidate stations based on various attributes (e.g., attributes that may be selected by a user), including, but not limited to, hours of operation (e.g., including automatic exclusion of stations not open on the current day (e.g., not open on Sunday while traveling on Sunday)), favorite stations, preferred fuel brands, preferred fuel types, stations with easy access from an interstate exit, stations in a track forward direction (i.e., not a track backward direction), stations at a truck stop, stations having a car wash, stations having repair/service facilities, stations having a convenience store or restaurant, stations that currently have the preferred fuel grade/type, and the like.

In some embodiments, the Fuel Service may provide a textual or graphical representation of stations, such as in response to a user request to view nearby stations on a navigation system. The Fuel Service may provide the representation of stations using any suitable format, such as in a Station Map or a Station List. A Station Map may show stations as highlighted POIs on a navigation map, for example.

A Station List may show stations in a list, such as a prioritized list. The list may be prioritized or ordered using any suitable technique or based on any suitable variety of factors. For example, the list may be ordered based on the current vehicle location (e.g., in order of distance from the vehicle, track forward stations (i.e., in the current direction of travel), on the same side of the road as the current direction of travel, or based on estimated calculated navigation route (i.e., list the stations with shortest travel first)). The list order may be selected based on proximity to a destination or POI, such as by prioritizing stations in order of distance from the destination. Alternatively or in addition, the stations in the list may be prioritized from lowest to highest price or based on a preferred brand (e.g., as previously selected by the user through User Preferences), out of a list of any suitable number of stations closest to a selected location, for example.

In some embodiments, the stations in the list may be prioritized to maximize on-route net cost savings, which may be done, for example, by selecting candidate stations along the navigation route; then by filtering out those stations that are beyond the driving range of the user's vehicle based on current fuel levels of the vehicle, and then by prioritizing the remaining stations based on cost. In some other embodiments, the stations in the list may be prioritized to maximize off-route net cost savings, which may be done, for example, by prioritizing a more distant station over a more proximal station if the estimated cost of fuel consumption in driving to the distant station is exceeded by the savings gained by not using closer more expensive stations.

The Fuel Service may provide any suitable information about the stations included in a Station Map or a Station List. For example, the Fuel Service may select a number of attributes to include in the Station Map or List for each displayed station, where the amount of information may be based on the display space or UI capabilities. The displayed attributes can include, for example, the price of one or more fuel types at the station. If a user preference establishes a preferred fuel type/grade, pricing may be restricted to show on the preferred fuel type(s) and/or grade(s). The price may also be highlighted with color or otherwise distinguished to visually represent pricing that is higher (e.g., red) or lower (e.g., green) than surrounding stations. The displayed attributes can additionally or alternatively include, for example, the station name, station brand, station logo (e.g., a large or small logo), distance to station, direction of station relative to track forward, station address, station services (e.g., whether or not the station includes a truck stop, car wash, restaurant, convenience store, a location close to an interstate exit, and the like), availability of one or more fuel types and/or fuel brands (e.g., fuel shortages), hours of operation (e.g., including open or closed on Saturday and Sunday), or any combination thereof. The displayed attributes can additionally or alternatively include, for example, estimated savings or extra cost (e.g., when a user is fueling at a particular station), which may be based on average fuel price of local stations and the capacity of the user's vehicle's fuel tank. This may emphasize real savings provided to the user by the Fuel Service.

In some embodiments, if data such as fuel availability and hours of operation are displayed, the product may also display the date the station information was last updated (e.g., STATION_UPDATE field). This way, the user can judge if rates may be subject to change.

The UI for the Fuel Service may include any other suitable options to enhance user ease and experience with the Fuel Service. For example, to avoid driver distraction while the vehicle is moving, the Fuel Service-enabled product may offer the ability to set user preferences for selecting stations, and for filtering and ordering resulting station selection lists. Any of the above-described attributes and list order priorities may be affected by the user preferences. In some embodiments, some user preferences may be set to default values by the vehicle or based on vehicle characteristics, such as the type/grade of fuel search and displayed or those able to be used by the vehicle, the total capacity of the vehicle's fuel tank, miles per gallon for range and cost savings calculations, and the like. As another option, the Fuel Service-enabled product may offer the ability for the user to designate a station identified during a search or on the navigation map as a “favorite”. Thereafter, the user may be provided with a favorites list to quickly view and compare prices or other attributes for their favorite stations. Furthermore, groups of favorites could be defined, such as “work commute” or “airport drive” favorite stations, so these stations could be recalled easily depending on the current trip route. As an example of another option, to avoid driver distraction, a voice control system and text to speech response can be used to make it easier to direct the product to perform more complex station searches.

The UI for the Fuel Service may include various alerts. For example, when operating in a “low price” alert mode, a Fuel Service-enabled product may continuously search for low priced fuel, which may be based on (1) a user-entered price threshold, or (2) a calculated threshold based on a review over time of prices for nearby stations (e.g., at least 5% less than the average fuel price). When enabled by the user, or automatically based on vehicle fuel level, the product may alert the user when driving within some distance of a station with a price below the threshold. As another example, when operating in an “alert when fuel low” alert mode, a Fuel Service-enabled product may continuously access the vehicle's fuel level and, when fuel is very low, it can alert the driver and request if a gas station search is desired. As another example, when operating in a “last station” alert mode, a Fuel Service-enabled product may produce an alert if the calculated range until critical low fuel level exceeds the distance from the next station along the navigation route to the following station, which may effectively provide the user with a “you need to get gas now” warning.

The UI for the Fuel Service may also provide a map of any suitable region that shows the relative average fuel prices or any other suitable attributes over that mapped region (e.g., using different colors).

The Fuel Service may be employed across any suitably-sized area or areas. For example, the Fuel Service may be supported for any number (e.g., 20, 100, 1,000, 14,000, 120,000, 200,000, 1,000,000, etc.) of fuel stations in any number of major urban markets in the United States or abroad. It should be understood that any suitable adjustments or implementation decisions may be made based on how expansive the Fuel Service is intended to cover.

In some embodiments, approximately 16 kbps or less of SID bandwidth may be used for Fuel messages, which may be allocated between Fuel Price Messages and Fuel Station Database Update Messages. Approximately 12 kbps or less may be used for transmission of Fuel Prices Messages. This bandwidth allocation can provide a full update of prices for up to 4 fuels for 120,000 stations within about 6 minutes. Approximately 4 kbps or less may be used for transmission of Fuel Station Database Update Messages, which may contain Reliable File Delivery-encoded data components. This may support reception of an Update File with cumulative reception times that may be roughly equal to the drive time for a quarter-full tank of fuel.

A product can include a number of modules for supporting the Fuel Service. In some embodiments, the product can include a receiver module. The product can further include a receiver module using a CMOS90 chipset (or later generation), for example, which may make use of RUDE Word service authorization.

The product may include electrical connections between the receiver chipset or module and the product's controller for a low-speed data port (LSDP) or high-speed data port (HSDP). This connection may convey the transmitted Fuel data from the receiver to the products HMI for processing and storage. The product may include non-volatile storage (e.g., flash or hard drive) to maintain an initial Fuel Station Database. For example, the non-volatile storage may have a capacity of approximately 17 MBytes, with potential to grow due to updates to approximately 25 Mbytes or more. Also, the product can include other types of storage (e.g., RAM, flash, or hard drive) to maintain the latest Fuel Prices data received over the air. The storage may have a capacity of, for example, approximately 2 MBytes with growth to around 2.5 MBytes or more. This data may not be used for long, so the data may be stored in volatile storage instead of a non-volatile storage. This data could be stored in volatile storage (e.g., RAM) or non-volatile storage (e.g., flash or hard drive), but non-volatile storage may be used in many embodiments such that most recently received Fuel Prices can be made available to the user immediately on power up, while waiting for the next full cycle of Fuel Prices to be received over the air. In some embodiments, Reliable File Delivery decoder software may run on the HMI to reconstruct Fuel Station Database Update files from data cumulatively received over the air, with sufficient RAM resources to decode a file size of 3 Mbytes, for example.

The product may, in some embodiments, include GPS resources to determine the current vehicle location relative to fuel station locations and/or a navigation subsystem that may be capable of accepting the location of a user-selected fuel station for trip routing.

The product may be configured to have sufficient HMI processing capabilities to parse data received from the receiver data port, store received Fuel Prices in local HMI memory, respond to user interactions to filter, display, sort, and select local fuel station information and pricing. In embodiments where Fuel Station Database Updated Messages are supported, the product may be further configured to have sufficient HMI processing capabilities to (1) accumulate incrementally received packets for Fuel Station Database Updates, and, when sufficient packets are received, execute the Reliable File Delivery decoder to reconstruct a full Station Database Update File, and (2) apply a received Station Database Update File against the HMI's local Station Database. The product may also be configured to display station information as icons with pricing summaries on a navigation display.

### Data Service Illustrative Embodiments (FIGS. 1-3)

As noted above, in some embodiments, the data for services can be transmitted over-the-air. Described below is illustrative protocol for the content and format of data sent over-the-air for a Fuel Prices data service. Exemplary protocol for a Parking Services or Flight Status Service would be analogous. In particular, FIG. 1 shows illustrative system 100 that can illustrate the format of data as received from a data port of a product's integrated receiver. For example, system 100 can be used by product planners, suppliers, developers, or any other suitable parties involved in implementing Fuel Prices services in an automotive or aftermarket product.

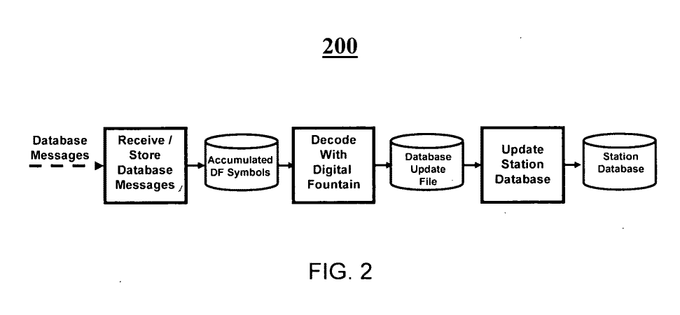

As used herein, at least with respect to FIGS. 1 and 2, the term “protocol” can refer to the format of data sent over-the-air, along with policies that can be observed by products implementing a user service based on the received data. As used herein, the term “HMI” can refer to a software implemented by a third party developer in a product using the Fuel data.

In some embodiments, responsibilities of the HMI can include maintaining a persistent database of reported stations and using a local copy of the Fuel Reference Baseline Database for initial values. Responsibilities of the HMI can also include receiving Fuel Database Update Messages over the air and updating the local, persistent station database accordingly. As another example, in some embodiments responsibilities of the HMI can include receiving Fuel Price Messages over the air and saving the data in local memory for reports to the user, and presenting a user interface for the service to the user.

Over-the-air (“OTA”) data for the Fuel Service can arrive in any suitable type of message. For example, the OTA data can arrive as a Fuel Station Database Update Message, as a Fuel Price Message, or as any other suitable type of message.

A Fuel Station Database Update Messages (e.g., “Database Messages”) can include a message that is sent using Reliable File Delivery. For example, Reliable File Delivery can utilize an encoding method that can allow a large data file to be incrementally sent as small blocks over a period of time (e.g., days, weeks, or the like). The original file may be reconstructed once an sufficient number of blocks have been accumulated by the receiver. In some embodiments, Database Update Messages can contain relatively slow-changing data (e.g. station brand changes, new stations added, etc.), as incremental updates to the Baseline Database compiled with the HMI. Each set of Database Update Messages can be sent over a particular period of time (e.g., 2 weeks, 4 weeks, or any other suitable period of time). For example, incremental updates can be provided to the Station Database every 2 to 4 weeks.

A Fuel Price Message (e.g., “Price Messages”), can include messages that are rapidly repeated on a repeat cycle time. For example, in some embodiments the full repeat cycle time can be on the order of 2 minutes (e.g., on initial service launch) to 6 minutes (e.g., as the service adds additional fuel type/grade reports). Price Messages can include a Price Reference Message, a Block Price Message, an Individual Price Message, and an Extended Price Message. A Price Reference Message can include a message providing reference prices for reported fuel types/grades. A Block Price Messages can include a messages providing the prices of a fuel type/grade for a block of stations with contiguous Station ID numbers. In some embodiments, the prices can be reported as the changes against the prices in the Price Reference Message. An Individual Price Message can include a message providing the prices of a fuel type/grade for specific stations with non-contiguous Station ID numbers. Similar to a block price message, the prices of an Individual Price Message can be reported as changes against the prices in the Price Reference Message. An Extended Price Message can include a message providing the prices of a fuel type/grade for specific stations, for the particular case where a price is outside a range of typical prices. Up Fuel Station Database Update Messages and Fuel Price Messages will be described in more detail in the descriptions to follow.

In some embodiments, one or more fields in a Fuel message payload can be encoded in a Tag-Length-Value (“TLV”) format. Encoding in this manner can allow for the addition of new fields in protocol updates without, for example, causing issues for products implementing the protocol. Through TLV encoding, a field can encoded by the three elements, Tag, Length, and Value. The Tag can include a one-byte fixed integer value that identifies this field. In some embodiments, the Tag can include a value from 1 to 255. The Length can include a one or three byte field indicating the length of the following field value: for Length is 0 to 255 bytes, a single UINT8 indicates length; for Length that is greater 255 bytes, the first byte can be zero to indicate the next two bytes (UINT16) contain length. The Value can include the value of the field, where that field is Length bytes long. For example, when Length=0, the Value field can be omitted in some embodiments. Although particular examples are given for the values and lengths of the TLV encoding, one skilled in the art could appreciate that any suitable TLV could be used, and that these particular examples are given for the purpose of illustration and not for limitation.

In some embodiments, the HMI code that parses TLV-encoded values can ignore and skip over any Tag value it does not understand. For example, the Length value can be used to calculate how far forward to skip. This may, for example, insure that adding new fields (e.g., with new Tag values) may not adversely affect legacy implementations.

In some embodiments, the multibyte fields can be in network byte order (e.g., big endian), whereas in other embodiments the multibyte fields can be in little endian order.

In some embodiments, one or more fields, subfields, or both can be Reserved for Future Use (e.g., “RFU”). For example, bit field containing bits not current defined may designate the undefined bits as RFU. In this case, a HMI software parsing this field can mask and ignore the RFU fields, as these fields may include unpredictable values.

As used herein, at least with respect to FIGS. 1 and 2, when a name appears in all caps (e.g., BRAND_CODE or STATION_XMF_ID), this can refer to the name of a logical data element. As used herein, at least with respect to FIGS. 1 and 2, when a name appears in mixed case (e.g., SdufBrandCode), this can refer to field names of elements in the protocol.

In some embodiments, The Fuel Station Database Update Messages (e.g., “Database Messages”) can include a single Database Update File with updates to one or more components of the HMI's local Fuel Database. For example, updates such as fuel types and grades, station brands, service banners, and station data can be included. For example, as illustrated by process 200 of FIG. 2, each Database Message can provide a portion of the Database Update File, and can be encoded using Reliable File Delivery. The HMI can accumulate these received blocks into nonvolatile local storage over time. For example, the blocks can be accumulated over a period of weeks depending on how often the radio is powered on. In response to a sufficient number of blocks being accumulated, the HMI can decodes the assembled blocks into the resulting Database Update File using Reliable File Delivery (“RFD”) decoder library software that can be integrated into the HMI. The Database Update File can then be used by the HMI to update affected fields in the local Station Database.

After a Database Update File has been received and decoded by the HMI, the Database Update File can include a particular format and contents. For example, the Database Update file can contain a header and four sections. The header and four sections can be positioned in the following order: Database Update File Header, Fuel Types and Grades Section, Station Brands Section, Service Banner Section, and Station Data Section. The header and each section will be described in more detail in the description to follow.

In some embodiments, the content of each Database Update File can provide incremental or differential updates to a specific Reference Baseline Database. For example, fields that have changed since the Reference Baseline Database was issued can be included in the Database Update File. In this case, if the name of a gas station has changed but the address and other information about the station has not changed, only the name field may be included in the Database Update File for that station. As another example, al fields that have changed since the Reference Baseline Database was issued can be included in the file. In this case, the updates can be incremental, rather than differential. As yet another example, the header of an Database Update File can include the version number of the Reference Baseline Database against which the updates are applied. In some embodiments, the HMI can ignore this value when applying updates. In this case, once the HMI starts receiving updates against a different (e.g., a more recent) Reference Baseline Database version than the one originally compiled with the HMI, the HMI may no longer allow the user to revert to a “factory default” version of the compiled Reference Baseline Database. This may be advantageous in some situations since older incremental updates may no longer be available in the Database Update File messages for an older Reference Baseline Database.

Table 21 shows an exemplary Database Update File Header that may, for example, appear at the start of a Database Update File.

TABLE 21
Database Update File Header

| | Field | |
|---|---|---|
| | Length | |
| Field Name | (Bytes) | Value/Description |
| SdufRefBaseline | 1 | The version of the Baseline |
| | | Database against which the |
| | | Database Update File provides |
| | | updates. (e.g., UINT8; Bits 0:4: |
| | | Baseline version, value 1-31; Bits |
| | | 5:7: RFU) |
| SdufExtLength | 2 | Length of following SdufExtFields. |
| | | Default value at service launch can |
| | | be set as “0” |
| | | (e.g., UINT16) |
| SdufExtFields | Var | Additional extension fields for the |
| | | Database Update File Header, and |
| | | can be used for future expansion. |

Table 22 shows an exemplary Fuel Types and Grades Section that may, for example, provide updates to the text descriptions for various Fuel Types and supported Grades. In some embodiments, the Fuel Types and Grades Section can apply various rules to its format and use. For example, in some embodiments, the TLV fields can include a positional significance (e.g., A SdufFuelTypeCode field can precede fields that update a specific FUEL_TYPE_CODE, and a SdufFuelGradeCode field can precede fields that update the specified FUEL_GRADE_CODE). As another example, in some embodiments, the TLV fields may appear in any order (e.g., to the extent that they do not conflict with the positional significance rule above). As yet another example, in some embodiments TLV fields including Tags not understood by the receiver can be ignored and skipped over by the receiver.

TABLE 22
Fuel Types and Grades Section

| | Field | |
|---|---|---|
| | Length | |
| Field Name | (Bytes) | Value/Description |
| SdufFTypesLength | 4 | Length of Fuel Types and Grades |
| | | Section, This can include the |
| | | SdufFTypesLength field. |
| | | (e.g., UINT32) |
| SdufFuelTypeCode | 3 | This can indicate start of an update |
| | (TLV) | for a specified FUEL_TYPE_CODE |
| | | TAG: 1 |
| | | LENGTH: 1 |
| | | VALUE: UINT8, 0-16, |
| | | indicating which |
| | | FUEL_TYPE_CODE is updated |
| | | with the following fields |
| SdufFuelTypeDescEn | Var | Update to English text |
| | TLV | FUEL_TYPE_DESC for a |
| | | FUEL_TYPE_CODE identified by |
| | | previous SdufFuelTypeCode field |
| | | TAG: 2 |
| | | LENGTH: 0-16 |
| | | VALUE: Unterminated ISO- |
| | | 8859-1string. |
| SdufFuelTypeDescFr | Var | Update to French text |
| | TLV | FUEL_TYPE_DESC for a |
| | | FUEL_TYPE_CODE identified by |
| | | previous SdufFuelTypeCode field |
| | | TAG: 3 |
| | | LENGTH: 0-16 |
| | | VALUE: Unterminated ISO- |
| | | 8859-1string. |
| SdufFuelTypeDescSp | Var | Update to Spanish text |
| | TLV | FUEL_TYPE_DESC for a |
| | | FUEL_TYPE_CODE identified by |
| | | previous SdufFuelTypeCode field |
| | | TAG: 4 |
| | | LENGTH: 0-16 |
| | | VALUE: Unterminated ISO- |
| | | 8859-1string. |
| SdufFuelGradeCode | 3 | Indicates start of a updates for a |
| | (TLV) | specified FUEL_GRADE_CODE, |
| | | applicable to a FUEL_TYPE_CODE |
| | | identified by previous |
| | | SdufFuelTypeCode field |
| | | TAG: 5 |
| | | LENGTH: 1 |
| | | VALUE: UINT8, 0-3, indicating |
| | | which FUEL_GRADE_CODE is |
| | | updated with the following fields |
| SdufFuelGradeDescEn | Var | Update to English text |
| | TLV | FUEL_GRADE_DESC for a |
| | | FUEL_GRADE_CODE and |
| | | FUEL_TYPE_CODE identified by |
| | | previous SdufFuelTypeCode and |
| | | SdufFuelGradeCode fields |
| | | TAG: 6 |
| | | LENGTH: 0-16 |
| | | VALUE: Unterminated ISO- |
| | | 8859-1string. |
| SdufFuelGradeDescFr | Var | Update to French text |
| | TLV | FUEL_GRADE_DESC for a |
| | | FUEL_GRADE_CODE and |
| | | FUEL_TYPE_CODE identified by |
| | | previous SdufFuelTypeCode and |
| | | SdufFuelGradeCode fields |
| | | TAG: 8 |
| | | LENGTH: 0-16 |
| | | VALUE: Unterminated ISO- |
| | | 8859-1string. |
| SdufFuelGradeDescSp | Var | Update to Spanish text |
| | TLV | FUEL_GRADE_DESC for a |
| | | FUEL_GRADE_CODE and |
| | | FUEL_TYPE_CODE identified by |
| | | previous SdufFuelTypeCode and |
| | | SdufFuelGradeCode fields |
| | | TAG: 9 |
| | | LENGTH: 0-16 |
| | | VALUE: Unterminated ISO- |
| | | 8859-1string. |

Table 23 shows an exemplary Station Brands Section that may, for example, provide updates to the text descriptions and logos for one or more station brands. In some embodiments, the Station Brands Section can apply various rules to its format and use. For example, in some embodiments, the TLV fields can include a positional significance (e.g., A SdufBrandCode field can precede fields that update a specific BRAND_CODE). As another example, in some embodiments, the TLV fields may appear in any order (e.g., to the extent that they do not conflict with the positional significance rule above). As yet another example, in some embodiments TLV fields including Tags not understood by the receiver can be ignored and skipped over by the receiver.

TABLE 23
Station Brands Section

| | Field | |
|---|---|---|
| | Length | |
| Field Name | (Bytes) | Value/Description |
| SdufBrandsLength | 4 | Length of Station Brands Section, |
| | | this can include the |
| | | SdufBrandsLength field. |
| SdufBrandCode | 3 | Can indicate the start of a updates |
| | (TLV) | for a specified BRAND_CODE. |
| | | TAG: 1 |
| | | LENGTH: 1 |
| | | VALUE: UINT8, 1-255, |
| | | indicating which BRAND_CODE is |
| | | updated with the following fields |
| SdufBrandName | Var | Update to text BRAND_NAME for a |
| | TLV | BRAND_CODE identified by |
| | | previous SdufBrandCode field |
| | | TAG: 2 |
| | | LENGTH: 0-24 |
| | | VALUE: Unterminated ISO- |
| | | 8859-1string. |
| SdufBrandLogoSmall | Var | Update to Small logo (e.g., PNG |
| | TLV | format) for a BRAND_CODE |
| | | identified by previous |
| | | SdufBrandCode field |
| | | TAG: 3 |
| | | LENGTH: 0-1280 |
| | | VALUE: Binary. PNG logo, 20 × |
| | | 20 pixel resolution. |
| SdufBrandLogoLarge | Var | Update to Large logo (e.g., PNG |
| | TLV | format) for a BRAND_CODE |
| | | identified by previous |
| | | SdufBrandCode field |
| | | TAG: 4 |
| | | LENGTH: 0-5120 |
| | | VALUE: Binary. PNG logo, 80 × |
| | | 80 pixel resolution. |

Table 24 shows an exemplary Service Banner Section that may, for example, provide updates to the text descriptions and logos for one or more service banners. In some embodiments, the Service Banner Section can apply various rules to its format and use. For example, in some embodiments, the TLV fields can include a positional significance (e.g., a SdufBannerCode field precedes fields that update a specific BANNER_CODE). As another example, in some embodiments, the TLV fields may appear in any order (e.g., to the extent that they do not conflict with the positional significance rule above). As yet another example, in some embodiments TLV fields including Tags not understood by the receiver can be ignored and skipped over by the receiver.

TABLE 24
Service Banner Section

| | Field | |
|---|---|---|
| | Length | |
| Field Name | (Bytes) | Value/Description |
| SdufBannerLength | 4 | Length of Service Banner Section, |
| | | this can include the |
| | | SdufBannerLength field. |
| SdufBannerCode | 3 | This can indicate the start of an |
| | (TLV) | update for a specified |
| | | BANNER_CODE |
| | | TAG: 1 |
| | | LENGTH: 1 |
| | | VALUE: UINT8, 0-255, |
| | | indicating which BANNER_CODE |
| | | is updated with the following fields |
| SdufBannerName | Var | Update to text BANNER_NAME for |
| | TLV | a BANNER_CODE identified by |
| | | previous SdufBannerCode field |
| | | TAG: 2 |
| | | LENGTH: 0-32 |
| | | VALUE: Unterminated ISO- |
| | | 8859-1string. |
| SdufBannerLogoSmall | Var | Update to Small logo (e.g., PNG |
| | TLV | format) for a BANNER_CODE |
| | | identified by previous |
| | | SdufBannerCode field |
| | | TAG: 3 |
| | | LENGTH: 0-1280 |
| | | VALUE: Binary. PNG logo, 20 × |
| | | 20 pixel resolution. |
| SdufBannerLogoLarge | Var | Update to Large logo (e.g., PNG |
| | TLV | format) for a BANNER_CODE |
| | | identified by previous |
| | | SdufBannerCode field |
| | | TAG: 4 |
| | | LENGTH: 0-5120 |
| | | VALUE: Binary. PNG logo, 80 × |
| | | 80 pixel resolution. |

Table 25 shows an exemplary Station Data Section that may, for example, provide updates to the various fields associated with one or more individual stations. In some embodiments, the Station Data section can contain the largest portion of data in the Database Update Field. Similar to the other sections, the Station Data Section can apply various rules to its format and use. For example, in some embodiments, the TLV fields can include a positional significance (e.g., a SdufStationXMFID field can precede fields that update fields for a specific STATION_XMF_ID). As another example, in some embodiments, the TLV fields may appear in any order (e.g., to the extent that they do not conflict with the positional significance rule above). As yet another example, in some embodiments TLV fields including Tags not understood by the receiver can be ignored and skipped over by the receiver.

TABLE 25
Station Data Section

| | Field | |
|---|---|---|
| | Length | |
| Field Name | (Bytes) | Value/Description |
| SdufFStationLength | 4 | Length of Fuel Types and |
| | | Grades Section, this can |
| | | include the SdufFStationLength |
| | | field. |
| | | UINT32 |
| SdufStationXMFID | Var | This can indicate the start of an |
| | (TLV) | update for a specified |
| | | STATION_XMF_ID |
| | | TAG: 1 |
| | | LENGTH: 1-3 |
| | | VALUE: 0-262, 143, |
| | | indicating which |
| | | STATION_XMF_ID is updated |
| | | with the following fields. |
| SdufStationPOIID | Var | Update to STATION_POI_ID |
| | TLV | for station identified by previous |
| | | SdufStationXMFID field |
| | | TAG: 2 |
| | | LENGTH: 0-8 |
| | | VALUE: Binary string |
| SdufStationLat | 6 | Update to STATION_LAT for |
| | TLV | station identified by previous |
| | | SdufStationXMFID field |
| | | TAG: 3 |
| | | LENGTH: 4 |
| | | VALUE: Latitude, float, |
| | | decimal degrees |
| SdufStationLong | 6 | Update to STATION_LONG for |
| | TLV | station identified by previous |
| | | SdufStationXMFID field |
| | | TAG: 4 |
| | | LENGTH: 4 |
| | | VALUE: Longitude, float, |
| | | decimal degrees |
| SdufStationName | Var | Update to STATION_NAME for |
| | TLV | station identified by previous |
| | | SdufStationXMFID field |
| | | TAG: 5 |
| | | LENGTH: 0-32 |
| | | VALUE: Unterminated |
| | | ISO-8859-1string. |
| SdufStationBrand | 3 | Update to STATION_BRAND |
| | TLV | code for station identified by |
| | | previous SdufStationXMFID |
| | | field. (References entry in |
| | | Station Brands section of |
| | | database.) |
| | | TAG: 6 |
| | | LENGTH: 1 |
| | | VALUE: UINT8, 0-255 |
| | | (0 = no well-known brand) |
| SdufStationAdrStreet | Var | Update to |
| | TLV | STATION_ADR_STREET for |
| | | station identified by previous |
| | | SdufStationXMFID field |
| | | TAG: 7 |
| | | LENGTH: 0-32 |
| | | VALUE: Unterminated |
| | | ISO-8859-1string. |
| SdufStationAdrCity | Var | Update to |
| | TLV | STATION_ADR_CITY for |
| | | station identified by previous |
| | | SdufStationXMFID field |
| | | TAG: 8 |
| | | LENGTH: 0-32 |
| | | VALUE: Unterminated |
| | | ISO-8859-1string. |
| SdufStationAdrState | Var | Update to |
| | TLV | STATION_ADR_STATE for |
| | | station identified by previous |
| | | SdufStationXMFID field |
| | | TAG: 9 |
| | | LENGTH: 0-2 |
| | | VALUE: Unterminated |
| | | ISO-8859-1string. |
| SdufStationAdrZip | Var | Update to STATION_ADR_ZIP |
| | TLV | for station identified by previous |
| | | SdufStationXMFID field |
| | | TAG: 10 |
| | | LENGTH: 0-6 |
| | | VALUE: Unterminated |
| | | ISO-8859-1string. |
| SdufStationPhone | Var | Update to STATION_PHONE |
| | TLV | for station identified by previous |
| | | SdufStationXMFID field |
| | | TAG: 11 |
| | | LENGTH: 0-10 |
| | | VALUE: BCD string, big |
| | | endian |
| SdufStationFuelCarried | 10 | Update to |
| | TLV | STATION_FUEL_CARRIED, as |
| | | an array of 16 4-bit nibbles, |
| | | where bit m of nibble n is 1 if |
| | | FUEL_GRADE_CODE m of |
| | | FUEL_TYPE_CODE n is |
| | | normally available at the station |
| | | TAG: 12 |
| | | LENGTH: 8 |
| | | VALUE: 16 nibbles |
| | | provided in 8 bytes, in big |
| | | endian order, with each |
| | | successive nibble |
| | | corresponding to |
| | | FUEL_TYPE_CODE 0, 1, 2, |
| | | etc. |
| SdufStationFuelIndex | Var | Update to |
| | TLV | STATION_FUEL_INDEX, as a |
| | | variable number of bytes, |
| | | where each byte indicates: |
| | | b0:3 Reported |
| | | FUEL_TYPE_CODE |
| | | b4:5 Reported |
| | | FUEL_GRADE_CODE |
| | | b6:7 RFU |
| | | The position of each byte in the |
| | | array can imply the “Fuel Price |
| | | Index”, used to de-reference |
| | | prices reported in the XM-Fuels |
| | | Pricing Messages to a |
| | | particular fuel type and grade |
| | | for this station. |
| | | In some embodiments, a |
| | | maximum of 8 fuel type/grades |
| | | can be reported for any |
| | | particular station, so the limit of |
| | | this array is 8 bytes per station. |
| | | TAG: 13 |
| | | LENGTH: 0-8 |
| | | VALUE: Binary array (see |
| | | above) |
| SdufStationServices | 3 | Update to |
| | TLV | STATION_SERVICES, a |
| | | bitfield that can indicate special |
| | | station services: |
| | | b0: Truck stop |
| | | b1: Restaurant |
| | | b2: Convenience Store |
| | | b3: Repair Services |
| | | b4: Interstate Access |
| | | b5: Car Wash |
| | | b6: RFU |
| | | b7: Station is completely |
| | | CLOSED |
| | | TAG: 14 |
| | | LENGTH: 1 |
| | | VALUE: UINT8 (see |
| | | above) |
| SdufStationWeekday | 3 | Update to |
| | TLV | STATION_WEEKDAY, a bitfield |
| | | that can indicate normal |
| | | weekday open and close time |
| | | encoded as: |
| | | b0:b3 = Open hour (0-15) |
| | | b4:b7 - Close hour (hour-9) |
| | | 0x00 = Open 24 hours |
| | | 0xFF = Hours unspecified |
| | | TAG: 15 |
| | | LENGTH: 1 |
| | | VALUE: UINT8 (see |
| | | above) |
| SdufStationSat | 3 | Update to STATION_SAT, a |
| | TLV | bitfield that can indicate normal |
| | | Saturday open and close time |
| | | encoded as: |
| | | b0:b3 = Open hour (0-15) |
| | | b4:b7 - Close hour (hour-9) |
| | | 0x00 = Open 24 hours |
| | | 0xFF = Hours unspecified |
| | | TAG: 16 |
| | | LENGTH: 1 |
| | | VALUE: UINT8 (see |
| | | above) |
| SdufStationSun | 3 | Update to STATION_SUN, a |
| | TLV | bitfield that can indicate normal |
| | | Sunday open and close time |
| | | encoded as: |
| | | b0:b3 = Open hour (0-15) |
| | | b4:b7 - Close hour (hour-9) |
| | | 0x00 = Open 24 hours |
| | | 0xFF = Hours unspecified |
| | | TAG: 17 |
| | | LENGTH: 1 |
| | | VALUE: UINT8 (see |
| | | above) |

Although exemplary databases with particular values were illustrated in Tables 21-25, one skilled in the art could appreciate that any suitable database could alternatively or additionally be used and that these databases are provided for the purpose of illustration and not as a limitation. For example, the particular field lengths, TLV values, or other values given in Tables 21-25 could alternatively include any other suitable values.

In some embodiments, a data encoding technology such as Reliable File Delivery (“RFD”) can be used to reliably deliver large files over a one-way transmission network. In this case, RFD can be used to encode a Database Update File into a stream of small blocks of data, called Reliable File Delivery symbols, at the Data Center. These symbols can be then transmitted by the service provider to receiving products along with other metadata required to identify the transmitted files. The HMI software in a product can receive and cache these symbols and metadata in non-volatile local storage (e.g., a hard drive or flash memory). In response to a sufficient number of symbols being cached, the HMI can run Reliable File Delivery decoder software to re-create the original source file from the cached symbols. This source file (e.g., the Database Update File) can then be processed by the HMI.

In some embodiments, when the Database Update File is larger than a predetermined size (e.g., 3 megabytes), the encoded file can be automatically transmitted using separate RFD encoded files, concatenated after reception. This may, for example, insure that decoding of any section of the complete file is less than 3 megabytes and may minimize RAM requirements for the HMI.

To convey Database Update File content, in some embodiments two message types can be transmitted, such as RFD Content Messages and RFD Metadata Messages. A RFD Content Message can contain the actual Reliable File Delivery encoded content (e.g., symbols) for the Database Update File. The RFD Metadata Messages can contain metadata useful for managing and decoding the RFD Content Messages.

Table 26 shows illustrative RFD Content Message values, where the RFD Content Message can convey the content of a Database Update File.

TABLE 26
RFD Content Message

| | Field | |
|---|---|---|
| | Length | |
| Field Name | (bytes) | Value/Description |
| RfdcSyncHeader | 6 | Value: $XMMX$ |
| | | Can be used by HMI parser to locate |
| | | start of this block when initially starting |
| | | reception after power up, or after |
| | | temporary loss of data due to signal |
| | | loss or data error. |
| RfdcFileID | 4 | Guaranteed globally unique file |
| | | identifier assigned by XM encoder. |
| | | Receiver can filter (ignore or store) RFD |
| | | Content packets based on this value. |
| | | This value can be linked to the |
| | | Metadata packet field FileID. |
| | | UINT32 |
| RfdcSymbolID | 4 | Symbol ID created by Reliable File |
| | | Delivery encoder, can be used to later |
| | | decode with this packet. |
| | | (e.g., UINT32) |
| RfdcSymSize | 2 | Size of symbol. |
| | | In some embodiments can be 16 bytes |
| | | to 16K (16384) bytes). |
| | | (e.g., UINT32) |
| RfdcSymbol | Var | Reliable File Delivery symbol, of |
| | | SymSize length in bytes. |
| | | Symbol may contain subsymbols. |

Table 27 shows illustrative RFD Metadata Message values. In some embodiments, RFD Metadata Message values can be transmitted separately from RFD Content Message values, and may not be encoded by Reliable File Delivery. For example, the RFD Metadata can be used by the HMI to determine which files are currently being transmitted with RFD Content packets, and which are appropriate to be cached and decoded by the HMI. RFD Metadata may moreover include information used for decoding the files. In some embodiments, however, the RFD Metadata may not be needed for receiving and storing each RFD Content packet. This may, for example, saves transmission bandwidth as RFD Metadata packets may be sent less frequently than RFD Content packets.

TABLE 27
RFD Metadata Message Values

| | Field | |
|---|---|---|
| | Length | |
| Field Name | (Bytes) | Value/Description |
| RfdmSync | 6 | Fixed pattern that can be used |
| | | by HMI parser to locate the |
| | | start of message payload within |
| | | an XM Application Packet when |
| | | initially starting reception after |
| | | power up or after temporary |
| | | loss of data due to signal loss |
| | | or data error. |
| | | (e.g., Value: $XMMX$) |
| RfdmLength | 2 | Length of remaining data in this |
| | | packet (e.g., in bytes) This may |
| | | not including the RFDmSync |
| | | and RFDmLength fields. |
| | | (e.g., UINT16) |
| RfdmSeq | 1 | Integer value that can be |
| | | incremented by 1 (e.g., rolling |
| | | over from 255 to 0) each time |
| | | any field in the RFD Metadata |
| | | packet changes since last |
| | | transmission. Can be used by |
| | | HMI software to determine if it |
| | | is necessary to parse this |
| | | instance of RFD Metadata |
| | | packet. In some embodiments, |
| | | if RFDmSeq has not change |
| | | since last time the RFD |
| | | Metadata packet was parsed, |
| | | the entire packet can be |
| | | ignored by the HMI. |
| | | (e.g., UINT8) |
| RfdmFileCount | 1 | Number of files represented in |
| | | the following repeated field |
| | | records. (e.g., can imply the |
| | | number of individual RFD- |
| | | encoded files that are currently |
| | | being transmitted.) |
| | | In some embodiments, the |
| | | Value may be set as 1 for Fuel |
| | | Services |
| | | (e.g., UINT8) |

The following TLV fields can repeat once for each RfdmFileCount:

| | | |
|---|---|---|
| RfdmFileID | 6 | Value for the globally unique |
| | (TLV) | FileID for the referenced file. |
| | | This value can link to the |
| | | RFDcFileID field found in RFD |
| | | Content packet headers. The |
| | | HMI uses this value to |
| | | associate received and cached |
| | | RFD symbols from the RFD |
| | | Content messages with the |
| | | parameters in this RFD |
| | | Metadata file. |
| | | TAG: 1 |
| | | LENGTH: 4 |
| | | VALUE: UINT32 |
| RfdmFileLength | 6 | Length of this file (before RFD |
| | (TLV) | encoding), in bytes. This value |
| | | can be used by the RFD |
| | | decoder after decoding the |
| | | original file to truncate the file to |
| | | the exact original size as |
| | | necessary. |
| | | TAG: 2 |
| | | LENGTH: 4 |
| | | VALUE: UINT32 Length |
| | | in bytes |
| RfdmSubSymbolSize | 4 | RFD subsymbol size used to |
| | (TLV) | encode this file (e.g., in bytes) |
| | | TAG: 3 |
| | | LENGTH: 2 |
| | | VALUE: UINT16 |
| RfdmFileCRC | 6 | CRC32 for the original file |
| | (TLV) | before RFD encoding. The HMI |
| | | can use this value to verify that |
| | | the fully decoded file is free of |
| | | any corruption. |
| | | TAG: 4 |
| | | LENGTH: 4 |
| | | VALUE: UINT32 |
| RfdmFileGroupTerminator | 1 | A zero byte appears at the end |
| | | of each group of TLV fields for |
| | | a single transmitted file. This |
| | | may, for example, allow new |
| | | TLV fields to be added in the |
| | | future without affecting legacy |
| | | implementations. |
| | | (e.g., UINT8, Value = 0) |
| RfdmFinalTerminator | 1 | An additional zero byte appears |
| | | at the end of the last set of TLV |
| | | fields for the last file, for the |
| | | benefit of TLV parsers. |
| | | (e.g., UINT8, Value = 0) |

As discussed above, Price Messages may provide updates to fuel prices. Because this pricing data can change rapidly, the Price Messages can be sent separately from the Station Database Update Messages. In some embodiments, Price Messages may not be sent using Reliable File Delivery like Station Database Update Messages. Price Messages can instead be repeated rapidly, such as in a “carousel” fashion.

There may be linking data elements between Price Messages components and the Station Databases. As described in greater detail below, the linking data elements may include a STATION_XMF_ID and STATION_FUEL_INDEX. The STATION_XMF_ID may be an identifier (e.g., an 18 bit identifier) for each station, which may be used to indicate which station price data is being reported. The STATION_FUEL_INDEX may be a suitable value (e.g., from 0 to 7), which may indicate which fuel type and grade is reported for a given station (e.g., through a series of indirect references).

Price Messages may be transmitted in any suitable message format. In some embodiments, the Price Messages may be sent as Price Reference Messages, Block Price Messages, Individual Price Messages, and/or Extended Price Messages. Price Reference Messages may contain a global reference price for each reported fuel type and grade. In some embodiments, the Block Price and Individual Price Messages may report individual station pricing against the reference prices for improved OTA bandwidth efficiency. Block Price Messages may report pricing for a given fuel index for a block of stations (e.g., up to 512 stations) with contiguous STATION_XMF_IDs. Block Price Messages may be bandwidth efficient, which can use a single byte per station that includes for each station: the fuel price, the age of the price report, and whether the fuel is current available at the station.

Individual Price Messages may report pricing for stations with non-contiguous STATION_XMF_IDs (e.g., for arbitrary fuel indices). Individual Price Messages may be less efficient than Block Price Messages, and may be used for stations reporting pricing for more than the average number of fuels per station. Extended Price Messages may report prices for stations that may not be expressed as a delta value against global reference prices. Like Individual Price Messages, Extended Price Messages can report pricing for stations with non-contiguous STATION_XMF_IDs, for arbitrary fuel indices. The Extended Price Messages may be less efficient than Block Price and Individual Price Messages, and may be used for stations with very low or very high prices.

The Fuel Application Server may dynamically allocate the reporting of prices between Block Price Messages, Individual Price Messages, and Extended Price Messages to optimize bandwidth efficiency. The Price Messages may contain header fields related to Cycles and Sequences, described in greater detail below.

In some embodiments, Price Reference Messages may be encapsulated in Application Packets with a specific Application Identifier, whereas Block Price Messages, Individual Price Messages, and Extended Price Messages may all encapsulated in Application Packets with a different Application Identifier. Fuel Message Encapsulation, including embodiments for OTA encapsulation of Price Messages, is described in greater detail below.

Price Messages may include any suitable number and types of content, and may take on any suitable format. The following description of the content and format may refer to Price Messages after the Price Messages have been parsed by the HMI from the Application Packets that may encapsulate them. In particular, Tables 200, 201, 202, and 203 (below) may provide illustrative fields for Price Reference Messages, Block Price Messages, Individual Price Messages, and Extended Price Messages, respectively. It should be understood that these tables are merely illustrative, and that any entries may be added, removed, or modified (e.g., the size or type (e.g., byte, char, etc.) may be changed, different values may be used for the fields, etc.) without departing from the scope of the invention.

Referring first to Table 28 below, Price Reference Messages may establish reference pricing for up to all reported fuel types/grades. In some embodiments, each instance of the Price Reference Messages can contain data for all reported fuel types/grades. Price Reference Messages may be repeated in the data stream at substantially regular intervals, such as about once every 15 seconds.

TABLE 28
Price Reference Messages

| | Field | |
|---|---|---|
| Field | Length | |
| Name | (Bytes) | Value/Description |
| PrmSync | 6 | Fixed pattern that may be used by HMI parser to |
| | | locate the start of message payload within an |
| | | Application Packet when initially starting |
| | | reception after power up or after temporary loss |
| | | of data due to signal loss or data error. |
| | | Value: $XMMX$ |
| PrmSeqID | 1 | UINT8: |
| | | b0:b3 Message Type identifier |
| | | Value 0x00, which may indicate that this is a |
| | | Price Reference Message. |
| | | b4:b7 Current PriceCycleSeq value. |
| | | May increment through 0, 1, 2, . . . 15, 0 . . . at the |
| | | start of a Cycle when, e.g., any data values in |
| | | any Price Messages have changed since the |
| | | previous Cycle. |
| PrmLast | 2 | UINT16: |
| Price | | b0:b13 PriceMessageSeq value for the last Price |
| Message | | Message of this cycle. (Effectively count-1 of |
| Seq | | the number of Block + Individual + Extended |
| | | Price Messages in the current Cycle.) |
| | | b14:b15 RFU |
| PrmCycle | 4 | Date and Time when the values in this Cycle were |
| TimeDate | | updated by the service. |
| | | 64 bit time_t, UTC |
| PrmDate | 8 | Date and Time of the Database Update File |
| Time | | assumed for data in the current Cycle of Price |
| | | Messages. |
| | | 64 bit time_t, UTC |
| PrmCount | 1 | UINT8: |
| | | b0:b2 Number of Fuel/Type Grades in this |
| | | message |
| | | b3:b7 RFU |

The following two fields may be repeated for each PrmCount:

| | | |
|---|---|---|
| PrmType | 1 | Indicates the fuel type and grade for which the |
| Grade | | following PrmRefPrice field applies |
| | | UINT8: |
| | | b0:b3 FUEL_TYPE_CODE, 0-15 |
| | | b4:b5 FUEL_GRADE_CODE, 0-3 |
| | | b6:b7: RFU |
| PrmRef | 2 | The global reference price for fuel for the fuel type |
| Price | | and code indicated by the previous |
| | | PrmTypeGrade field. |
| | | UINT16: |
| | | b0:b13 Fuel price in $0.01 units, 0 to $163.00 |
| | | Values >163000 are RFU |
| | | b14:b15 Delta Unit Multiplier: |
| | | Applied to delta prices from Block Price and |
| | | Individual Price Messages before adding the |
| | | delta to the reference price: |
| | | 0b00 No multiplier (delta may be $0.01 units) |
| | | 0b01 Multiplier × 5 (delta may be $0.05 units) |
| | | 0b10 Multiplier × 10 (delta may be $0.10 units) |
| | | 0b11 RFU |

Referring now to Table 29 below, each Block Price Message may report pricing, age of pricing, and/or availability of fuel for a single specified Fuel Index for a block of stations with contiguously numbered STATION_XMF_ID numbers. Multiple Block Price Messages may be used to report prices for all stations.

In some embodiments, a station may be included in a Block Price Message for a given Fuel Index, even though pricing is not reported for that station for that Fuel Index. This may be beneficial for bandwidth efficiency reasons. In particular, this can maximize use of Block Price Messages over Individual and Extended Price Messages, which can improve bandwidth efficiency.

TABLE 29
Block Price Messages

| | Field | |
|---|---|---|
| | Length | |
| Field Name | (Bytes) | Value/Description |
| BpmSync | 6 | Fixed pattern that may be used by HMI parser to |
| | | locate the start of message payload within an |
| | | Application Packet when initially starting |
| | | reception after power up or after temporary loss |
| | | of data due to signal loss or data error. |
| | | Value: $XMMX$ |
| BpmSeqID | 1 | UINT8: |
| | | b0:b3 Message Type identifier |
| | | Value 0x01, which may indicate that this is a |
| | | Block Price Message. |
| | | b4:b7 Current PriceCycleSeq value. |
| | | May increment through 0, 1, 2, . . . 15, 0 . . . at |
| | | the start of a Cycle when, e.g., any data values |
| | | in any Price Messages have changed since the |
| | | previous Cycle. |
| BpmSeq | 2 | UINT16: |
| | | b0:b13 PriceMessageSeq value for this message. |
| | | 0 if this message is the start of a Cycle. |
| | | May match value in PrmLastPriceMessageSeq |
| | | if this message is the last message of a Cycle |
| | | b14:b15 RFU |
| BpmStart | 2 | Lower 16 bits of the 18 bit STATION_XMF_ID |
| XMFID | | for the first reported station in the block of |
| | | stations reported by this message. |
| | | UINT16 |
| BpmFuel | 1 | Indicates the single STATION_FUEL_INDEX |
| Index | | reported by this message |
| | | UINT8: |
| | | b0:b2 STATION_FUEL_INDEX, 0-7 |
| | | b3:b4 RFU |
| | | b5:b6: Upper 2 bits of the 18 bit |
| | | STATION_XMF_ID, to be joined with |
| | | BpmStartXMFID |
| | | b7: Upper bit of 9 bit BpmCount field |
| BpmCount | 1 | UINT8 |
| | | Lower 8 bits of a 9 bit count of contiguously |
| | | numbered stations may be reported by this |
| | | message, 0-511 |
| | | Value may be 1-n |
| | | (i.e. value 0 = count of 1, value 511 = count of |
| | | 512) |

The following field can be repeated for each BpmCount:

| | | |
|---|---|---|
| BpmPrice | 1 | For the station with STATION_XMF_ID = |
| | | BpmStartXMFID + byte offset into BpmPrice |
| | | block |
| | | UINT8: |
| | | b0:b5 Price Delta |
| | | Reports delta from PrmRefPrice for the fuel |
| | | type/grade reported as BpmFuelIndex for this |
| | | station. |
| | | This delta may be added to the reference price |
| | | to obtain the actual price for the station. |
| | | Special Values can include: |
| | | 0x3F - Indicates price not reported for this station. |
| | | (i.e., this fuel index usually reported for this |
| | | station, but current pricing not available) |
| | | 0x3E - Station is out of this fuel |
| | | 0x3D - Ignore this station value. (i.e., this fuel |
| | | index not usually reported for this station, or the |
| | | price is reported in a different Individual Price |
| | | Message or Extended Price Message) |
| | | b6:b7 Age of price report: |
| | | 0b00 Pricing within 1 day old |
| | | 0b01 Pricing within 2 days old |
| | | 0b10 Pricing within 3 days old |
| | | 0b11 Pricing older than 3 days old |

Referring now to Table 30 below, Individual Price Messages may report pricing, age of pricing, and availability of fuel for an arbitrary Fuel

Index for individual stations, even if possessing non-contiguous STATION_XMF_ID numbers. Depending on the number of stations employing only Individual Price Messages, multiple Individual Price Messages may be used to report prices for all stations.

TABLE 30
Individual Price Messages

| | Field | |
|---|---|---|
| | Length | |
| Field Name | (Bytes) | Value/Description |
| IpmSync | 6 | Fixed pattern that may be used by HMI parser to |
| | | locate the start of message payload within an |
| | | Application Packet when initially starting |
| | | reception after power up or after temporary loss |
| | | of data due to signal loss or data error. |
| | | Value: $XMMX$ |
| IpmSeqID | 1 | UINT8: |
| | | b0:b3 Message Type identifier |
| | | Value 0x02, which may indicate that this is an |
| | | Individual Price Message. |
| | | b4:b7 Current PriceCycleSeq value. |
| | | May increment through 0, 1, 2, . . . 15, 0 . . . at |
| | | the start of a Cycle when, e.g., any data values |
| | | in any Price Messages have changed since the |
| | | previous Cycle. |
| IpmSeq | 2 | UINT16: |
| | | b0:b13 PriceMessageSeq value for this message. |
| | | 0 if this message is the start of a Cycle. |
| | | May match value in PrmLastPriceMessageSeq |
| | | if this message is the last message of a Cycle |
| | | b14:b15 RFU |
| IpmCount | 1 | UINT8: |
| | | Number of stations reported in this message, |
| | | 1-256 |
| | | Value may be 1-n |
| | | (i.e. value 0 = count of 1, value 255 = count of |
| | | 256) |

The following three fields can be repeated for each IpmCount:

| | | |
|---|---|---|
| Ipm | 2 | Lower 16 bits of the 18 bit STATION_XMF_ID |
| Station | | reported in the following fields. |
| XMFID | | UINT16 |
| IpmFuel | 1 | May indicate the STATION_FUEL_INDEX |
| Index | | reported by the following fields |
| | | UINT8: |
| | | b0:b2 STATION_FUEL_INDEX, 0-7 |
| | | b3:b4 RFU |
| | | b5:b6: Upper 2 bits of the 18 bit |
| | | STATION_XMF_ID, to be joined with |
| | | IpmStationXMFID |
| | | b7: Database Synchronization Used if 1 |
| IpmPrice | 1 | For the station with STATION_XMF_ID = |
| | | IpmStationXMFID and for |
| | | STATION_FUEL_INDEX = IpmFuelIndex: |
| | | UINT8: |
| | | b0:b5 Price Delta |
| | | May report delta from PrmRefPrice for the fuel |
| | | type/grade reported as IpmFuelIndex for this |
| | | station. |
| | | This delta may be added to the reference price |
| | | to obtain the actual price for the station. |
| | | Special Values: |
| | | 0x3F - May indicate price not reported for this |
| | | station. (i.e., this fuel index usually reported for |
| | | this station, but current pricing not available) |
| | | 0x3E - Station is out of this fuel |
| | | 0x3D - RFU |
| | | b6:b7 Age of price report: |
| | | 0b00 Pricing within 1 day old |
| | | 0b01 Pricing within 2 days old |
| | | 0b10 Pricing within 3 days old |
| | | 0b11 Pricing older than 3 days old |

Referring now to Table 31 below, Extended Price Messages may report prices for a station that may not be expressed as a delta value against global reference prices. Extended Price Messages may be used for stations with unusually low or high prices compared to average pricing values. In some embodiments, these message can report pricing, age of pricing, and availability of fuel for an arbitrary Fuel Index for individual stations, even if possessing non-contiguous STATION_XMF_ID numbers. Depending on the number of stations requiring Extended Price Messages, multiple Extended Price Messages may be used to report prices for all stations.

TABLE 31
Extended Price Messages

| | Field | |
|---|---|---|
| | Length | |
| Field Name | (Bytes) | Value/Description |
| EpmSync | 6 | Fixed pattern may be used by HMI parser to |
| | | locatethe start of message payload within an |
| | | Application Packet when initially starting |
| | | reception after power up or after temporary loss |
| | | of data due to signal loss or data error. |
| | | Value: $XMMX$ |
| EpmSeqID | 1 | UINT8: |
| | | b0:b3 Message Type identifier |
| | | Value 0x03, which may indicate that this is an |
| | | Extended Price Message. |
| | | b4:b7 Current PriceCycleSeq value. |
| | | May increment through 0, 1, 2, . . . 15, 0 . . . at |
| | | the start of a Cycle when, e.g., any data values in |
| | | any Price Messages have changed since the |
| | | previous Cycle. |
| EpmSeq | 2 | UINT16: |
| | | b0:b13 PriceMessageSeq value for this message. |
| | | 0 if this message is the start of a Cycle. |
| | | May match value in PrmLastPriceMessageSeq |
| | | if this message is the last message of a Cycle |
| | | b14:b15 RFU |
| EpmCount | 1 | UINT8 |
| | | Number of stations reported in this message, |
| | | 1-256 |
| | | Value may be 1-n |
| | | (i.e. value 0 = count of 1, value 255 = count of |
| | | 256) |

The following three fields can be repeated for each EpmCount:

| | | |
|---|---|---|
| Epm | 2 | Lower 16 bits of the 18 bit STATION_XMF_ID |
| Station | | reported in the following fields. |
| XMFID | | UINT16 |
| EpmFuel | 1 | May indicate the STATION_FUEL_INDEX |
| Index | | reported by the following fields |
| | | UINT8: |
| | | b0:b2 STATION_FUEL_INDEX, 0-7 |
| | | b3:b4 RFU |
| | | b5:b6: Upper 2 bits of the 18 bit |
| | | STATION_XMF_ID, to be joined with |
| | | EpmStationXMFID |
| | | b7: Database Synchronization Used if 1 |
| EpmPrice | 2 | For the station with STATION_XMF_ID = |
| | | EpmStationXMFID and for |
| | | STATION_FUEL_INDEX = EpmFuelIndex: |
| | | UINT16: |
| | | b0:b13 Fuel price in $0.01 units, 0 to |
| | | $163.00 |
| | | Values >163000 are RFU |
| | | b14:15 Age of price report: |
| | | 0b00 Pricing within 1 day old |
| | | 0b01 Pricing within 2 days old |
| | | 0b10 Pricing within 3 days old |
| | | 0b11 Pricing older than 3 days old |

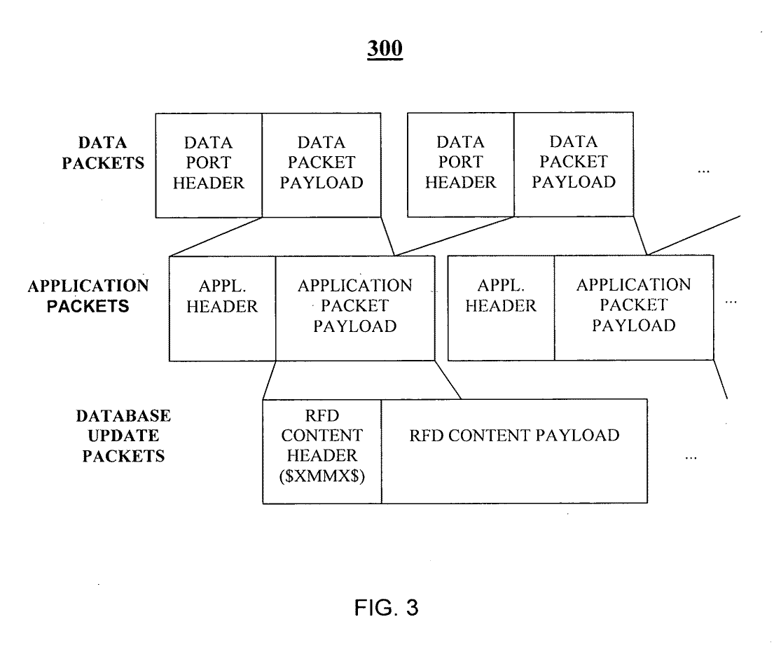

In some embodiments, multiple levels of data encapsulation 300 may be used for Fuel Messages, as illustrated in FIG. 3 for the Database Update Messages. The structure may be similar for Price Messages. For example, there may be three levels of data encapsulation in some embodiments, including a first level with Data Packets and Data Port Headers, a second level with Application Packets, and a third level with Fuel Messages.

Referring first to the first level, Data Port Headers may, in some embodiments, precede all data extracted from the receiver chipset or module. Data Port Headers may indicate which SID (channel) the following packet of data was received from, so that multiple SIDs can be extracted at the same time and de-interleaved by the HMI software. The payload following a Data Port Header may be referred to as a Data Packet.

Referring now to the second level, fuel messages may be transported using Application Packets, as may be all content received with many data services. Each Fuel message can use many Application Packets. For example, in some implementations, a single Application Packet may be constrained to a maximum 424-byte payload plus terminating 2 byte CRC, so Fuel messages may extend over multiple Application Packets. The Application Packet can ensure error free and continuous data (i.e., no packet drops) may be routed to the proper protocol layers. In some embodiments, one Application Identifier may be used in Application Packets to identify packets containing Database Update Messages (RFD Content and RFD Metadata payloads), and a different Application Identifier may be used in Application Packets to identify packets containing Price Reference Messages, and another different Application Identifier may be used in Application Packets to identify packets containing Block Price, Individual Price, and Extended Price Messages. It should be understood, however, that this is merely illustrative.

Referring now to the third level, Application Packets may encapsulate Fuel Messages (described above). In some embodiments, each Fuel Message may include a Sync Pattern (e.g. “$XMMX$” or “!META!”) in the header for use by the HMI parsing software to find the start of a message on initial power up, or after detecting a packet loss due to lost signal or errored packets. The three levels are described in greater detail below.

The payload of each Data Packet may include a block of data received over the air for a particular service (e.g., identified by a SID in the Data Port Header). The Data Port Header may be formed by the receiver chipset itself, and may not be a part of the original over-the-air payload for an application. The Data Port header can indicate which SID the enclosed packet was received on. For example, a Data Port Header might indicate it contains data received from a particular data channel carrying Fuel messages or from a channel carrying Traffic-related data.

Application Packets may be part of the original data sent over the air, and may wrap application-specific payloads with a common header, referred to sometimes as an Application Header. The Application Header can indicate the Application ID of the enclosed packet. For example, an Application Header might indicate Application ID 150, which may be the App ID for the Database Update Messages, i.e., RFD Content and RFD Metadata, sent over a particular SID. An Application Header with Application ID 151 may include payload for Reference Price Messages, and an Application Header with Application ID 152 may contain payload for Block Price, Individual Price, and Extended Price Messages.

Application-specific payloads within the Application packets may each have their own unique headers and data format. In some embodiments, the payloads may each include some kind of synchronization byte sequence, length data, and CRCs. However, the formats for Fuel, weather, traffic, stock, and sports may be all different.

As illustrated in FIG. 3, one attribute of the above packet structure may be considered for proper implementation of parsing code: the packets are not necessarily frame-aligned with their parent packet. This means that an Application Header may not necessarily appear immediately following a Data Port Header; e.g., the data following a Data Port Header for SID X (for some suitable value of X) may be in the middle of an Application Packet for Fuel data. Likewise, a message header may not necessarily appear after each Application Header; e.g., the data following an Application Header for Application ID 150 on SID X may be in the middle of a RFD Content message. Each payload in the packet hierarchy may effectively be an asynchronous stream of data.

This asynchronous nature indicates that a host data parser may be implemented as a set of independent state machines: one for the Data Packet level, one for the Application Packet level, and one for the Fuel messages. Each of these levels of packets can contain sync pattern bytes in their respective headers to allow for re-synchronization of the data in the case of lost packets. Also, sequence number fields may be included in the Application Header to assist in detecting missing data.

Referring again to the first level of data encapsulation, Data Packets may encapsulate all data captured from the receiver chipset or module's data port or a modules command and control port, capable of multiplexing data-related packets

In some embodiments, the Data Port Header may not contain a packet length field. The end of an Data Port Packet may be reliably detected by the start of the next Data Port Header.

Referring again to the second level of data encapsulation, Application Packets may appear in the payload following Data Port Headers. Each Application Packet may begin with a 6 byte Application Header, and may end with a 16-bit CRC, as shown in Table 33: Application Packet below.

TABLE 33
Application Packet

| | | |
|---|---|---|
| Field | | |
| Name | Length | Description |

Application Header

| | | |
|---|---|---|
| APP_SYNC | 8 bits | Value = 0xF0. Sync byte for detecting |
| | | an Application |
| APP_ID | 8 bits | Application ID. 0 to 255, which may |
| | | indicate application of payload. |
| APP_LEN | 16 bits | Number of bytes in the payload of the |
| | | Application Packet, not including this |
| | | header or the terminating CRC. |
| | | (e.g., Big Endian) |
| APP_SEQ | 8 bits | Application Sequence Number. |
| APP_HDR_CRC | 8 bit | Lower 8 bits of: |
| | | CRC-16 (X¹⁶ + X¹² + X⁵ + 1) |
| | | performed on the first 4 bytes of the |
| | | Application Header. |

Application Payload

| | |
|---|---|
| Payload | Variable |

Application CRC

| | | |
|---|---|---|
| APP_CRC | 2 Bytes | CRC-16 (X¹⁶ + X¹² + X⁵ + 1) |
| | | performed on the payload bytes. |
| | | (e.g., Big Endian) |

When the parser is searching for an Application Header (e.g., during initial synchronization, or when re-synchronizing after a lost packet), it can look for the APP_SYNC byte within the Data Packet payload, then verify a valid header by performing the CRC calculation and comparing the results to the APP_HDR_CRC field.

APP_ID may indicate the Application ID (also referred to sometimes as an Application Type) of the data in the packet. Application IDs may be fixed identifiers (e.g., 0 through 255), assigned by the service. Application IDs may imply the application-specific format of the data that follow the Application Header. For example, the Fuel data may be assigned Application IDs 150, 151, and 152, and the stock ticker feed may use Application IDs 51, 52, and 53. In some embodiments, Application IDs can be unique only within a given channel. For example, an Application ID 8 may appear on both SID 255 and SID 252 but represent different applications.

APP_LEN may indicate the length of the Payload. Note that one Application Packet can extend over multiple Data Packets.

The maximum length of the Application Header+Payload+Application CRC for data services sent over either BDC or SC channels may be 432 bytes, for example. Therefore, in some embodiments, the maximum value APP_LEN may be 424 bytes. The APP_SEQ field may be increased by 1 (e.g., from 0 to 255 to 0), for each Application Packet for a given APP_ID. These sequence numbers may be independent for each Application ID. A parser can use this field to detect missing Application Packets in the extracted data stream. In some embodiments, there may be no other indication of a missing Application Packet (e.g. no “data missing” message).

Application Packets are not necessarily frame-aligned with Data Packets. This means the Application Header for the next Application Packet may not necessarily follow directly after an Data Port Header. Upon initial synchronization and re-synchronization after a lost packet, it may be necessary for a parser to search the payload of a Data Packet for an Application Header by locating potential APP_SYNC bytes and verifying the following APP_HDR_CRC value.

A single Data Packet can contain multiple Application Packets, including packets with different Application IDs. Conversely, multiple Data Packets may be needed to send a single Application Packet. Relative framing of Data Packets and Application Packets can be completely asynchronous.

Though Application Headers can be protected by a CRC, there is a slight possibility that the payload data may contain a natural sequence of 6 bytes that appears as a valid Application Header. This could result in a false detection if a parser has lost data sync and is searching for the Application Header. To reduce this possibility, the parser performing synchronization can optionally verify that the APP_LEN field of a header found with proper CRC is 424 or less. If APP_LEN is greater than 424, the parser can immediately restart its search for a valid header after the APP_SYNC byte in the false header. Also, a correct APP_CRC for the entire packet can be used as further verification that the parser has synchronized with a valid header.

Referring again to the third level of data encapsulation, Fuel Messages may be carried in the Application Packets. In some embodiments, all Fuel Messages may include a header followed by the message payload. These headers may contain synchronization patterns (e.g., “$XMMX$”, “!META!”) to aid in locating the headers during initialization or after loss of packets. Also, one message (e.g., header+data) may span multiple Application Packets. Therefore, on initial synchronization or re-synchronization after packet loss, the application-specific parser may need to examine and discard multiple Application Packets before it finally detects the Sync Pattern of a message header.

In some embodiments, Fuel messages may be transmitted repeatedly over a particular SID (e.g., SID X). Database Update Messages (e.g., RFD Content and RFD Metadata payload) may be encapsulated in Application Packets with App ID 150 (decimal). Price Reference Messages may be encapsulated in Application Packets with App ID 151 (decimal). Block Price Messages, Individual Price Messages, and Extended Price Messages may all be encapsulated in Application Packets with App ID 152 (decimal). These SID and App ID values may or may not be fixed (e.g., hard-coded in the receiver).

In some embodiments, the nominal bandwidth allocated to SID X for all Fuel messages is 16 kbps, although any other suitable value may be used. Of this bandwidth, about 12 kbps can be used for Price Messages and 4 kbps used for Database Update Messages.

Each complete transmission of all Price Messages for all stations may sometimes be referred to as a “Cycle.” Each Cycle can include hundreds of individual Block Price Messages, Individual Price Messages, and Extended Price Messages. In some embodiments, these messages may all be encapsulated in Application Packets with App ID 152.

Additionally, Price Reference Messages may be sent periodically (e.g., encapsulated in Application Packets with App ID 151). Each Price Reference Message may be complete. That is, each Price Reference Message may include all reference prices for reported fuel types/grades. Price Reference Messages are repeated substantially regularly, such as about once every 15 seconds.

Fields may be provided in all the Price Messages to give the HMI the option to detect and track when it has received all Price Messages for a complete Cycle, whether a subsequent Cycle can be ignored due to no change in content from the previously captured Cycle, and the time/date data was updated for a received Cycle, e.g., to determine if a previously cached Cycle, stored in persistent memory before last power cycle, might still be useful to the user while waiting to process the next Cycle after a power up.

Each time a new Cycle is started and the data content of any Price Messages has changed since the previous Cycle, a 4 bit counter PriceCycleSeq can be incremented (0, 1, 2, . . . 15, 0, 1 . . . ). This field may appear in the header of each Price Message. The Price Reference Message may also include a field PrmTimeDate that can indicate the time and date when the content of the Price Messages was last updated.

In some embodiments, every Block Price, Individual Price, and Extended Price Message (e.g., encapsulated in Application Packets with App ID 152) may include a 14 bit PriceMessageSeq number. This number can be shared and incremented for every Block, Individual, and Extended Price Message in a cycle (e.g., starting from 0 for the first message of a cycle), with the last message of the cycle equal to the value in PrmLastPriceMessageSeq of the Price Reference Message. PriceMessageSeq can be incremented for each of these messages, regardless of if the message is a Block Price, Individual Price, or Extended Price Message (any of which can appear in any order).

The service can determine if it has captured all of the data in a current cycle. In some embodiments, the HMI can use the PriceMessageSeq, PriceCycleSeq, and PrmLastPriceMessageSeq values to determine if it has completely captured all data in a Cycle. If the HMI determines that it has (1) captured and stored Block Price, Individual Price, and Extended Price Messages without skipping any PriceMessageSeq value from 0 to the value in PrmLastPriceMessageSeq, and (2) the value of PriceCycleSeq has not changed during this capture process, then the HMI can conclude it has received all data in the current Cycle.

In some embodiments, the service may ignore duplicate cycles. If the HMI has determined it has completely captured the current Cycle using the method above, the HMI can optionally ignore further Price Messages until it detects a different value for PriceCycleSeq than that for the Cycle it has captured. Since Price Message content may not be updated for some time (e.g., hours), this can significantly decrease content updating overhead over time.

The service may be able to use cached Price data. For example, the HMI can optionally store the currently captured Price Message data to non-volatile storage before powering down, storing the associated PrmTimeDate with the data. On the next power-up, the HMI can compare the stored PrmTimeDate with the current date and time, to determine if the stored data is still useful to the user while waiting to capture a fresh cycle of data. Some additional sophistication can be added (e.g., if the PrmTimeDate indicates the data is one day old, then price ages reported to the user can be incremented by a day until a new Cycle is received). Also, if the HMI determines the stored PrmTimeDate matches the PrmTimeDate in a current Price Reference Message after power up, there may be no need to capture the current Cycle.

There may be several levels of indirection used to resolve a “delta price” into a final price for a specific station/type/grade.

In the Station Database, the STATION_FUEL_INDEX structure may determine which fuel type/grade is reported as fuel 0, 1, 2, etc. for that station. For explanation purposes, obtaining the fuel type/grade code for a given station and FuelIndex (0 . . . 7) could be represented as:
FType=STATION_FUEL_INDEX[StationID, FuelIndex, TYPE]
FGrade=STATION_FUEL_INDEX[StationlD, FuelIndex, GRADE]

Potentially 16×4=64 fuel types/grades that could be tracked with pricing. However for any individual station, in some embodiments, only up to 8 of any combination of fuel types/grades may be supported with pricing data.

As Price Messages are received, over the air, the HMI can save the delta prices for each station, deferring calculations of actual pricing to later, when needed for UI access. Delta prices could be stored in a table, such as:
DeltaFuelPriceTable[StationID, FuelIndex]

In the Price Reference Message, the PrmRefPrice field can establish a global reference price for each fuel type/grade that is reported by any station. As an example, assume this data may be stored in a table by the HMI as follows:
RefPrice=RefPriceTable[FType, FGrade]

In the Block Price and Individual Price Messages, fuel price deltas (e.g. BpmPrice-b0:b5) may be for a FuelIndex, not for a fixed fuel type/grade. Therefore the following could represent the way the HMI stores an updated fuel price for a station with StationID, using the Block Price Message as an example:
StationID=(a particular StationXMFID implied from the Block Price Message)
FuelIndex=BpmFuelIndex-b0:b2 (from Block Price Message)
DeltaPrice=BpmPrice-b0:b5 (from Block Price Message)
DeltaFuelPriceTable[StationID, FuelIndex]=DeltaPrice

Later, when pricing information is retrieved for station StationID responsive to UI interaction, pricing information for a one of the reported fuel types/grades for that station, represented by FuelIndex, can be accessed and calculated with:
FType=STATION_FUEL_INDEX[StationID, FuelIndex, TYPE]
FGrade=STATION_FUEL_INDEX[StationID, FuelIndex, GRADE]
CurPrice=DeltaFuelPriceTable[StationID, FuelIndex]+RefPriceTable[FType, FGrade]

Block Price Messages may be most efficient if there is a price reported for as many contiguous stations as possible. By making each of these messages report a “fuel index” instead of specific fuel type/grade, it may eliminate waste from skipped stations due to differing and possibly sparse and random distribution of reported fuel type/grades for all stations.

Strict “synchronization” of Database Update File reception/installation and Price Message content may not be required. Operational policies may insure the user is not mislead by reported pricing information if, for example, a receiver is still receiving a Database Update File while also receiving Price Messages generated on the basis of that update.

However, in some limited cases, it may be necessary to insure a price for a certain station and/or fuel type/grade is not reported until a specific Database Update File (or later) is received and installed by the HMI. In cases where this is important, in some embodiments, the service may report the affected price using an Individual Price Message or Extended Price Message, asserting the field IpmFuelIndex-b7 or EpmFuelIndex-b7, respectively. Responsive to detecting this, the HMI may check the installed Database Update File is not stamped with a time/date earlier than the time/date indicated in the PrmDateTime field of the Price Reference Message. If it is earlier, the affected price may be reported as “not available”. If it is the same date or later, the price can be reported as usual. This technique may be used for occasional data changes that need a guard interval, such as a station changing the meaning of some of its FuelIndex values, or re-using an old Station ID for a different station.

From time to time, the service may publish a new Baseline Station Database for use by products as the default database, complied with the released HMI code. These Baseline Databases can represent a snapshot of known station data at the time the Baseline Database is published. The updated data elements included in Database Update Messages can reflect any suitable changes since a selected Baseline Database. In some embodiments, the database update publication dates may not be based on a fixed or regular scheduled. For example, database update publication dates may be driven by significant updates to the data, such as roughly once a year as a maximum update frequency.

Each Baseline Database may have an Integration Period in which products under development can integrate that version of the Baseline Database. The publication of the next Baseline Database may mark the end of the Integration Period for the previously published Baseline Database. In some embodiments, each Baseline Database may have an Update Period of at least four years from the end of its Integration Period for use as a basis for Fuel Station Database Update Messages. This means the service can transmit incremental updates with the Fuel Station Database Update Messages against a particular Baseline Database for a minimum of four years after the end of the Integration Period for that Baseline Database. It should be understood that any other length of time may be used instead.

### Generic Flow Chart; Exemplary Screen Shot (Fuel)

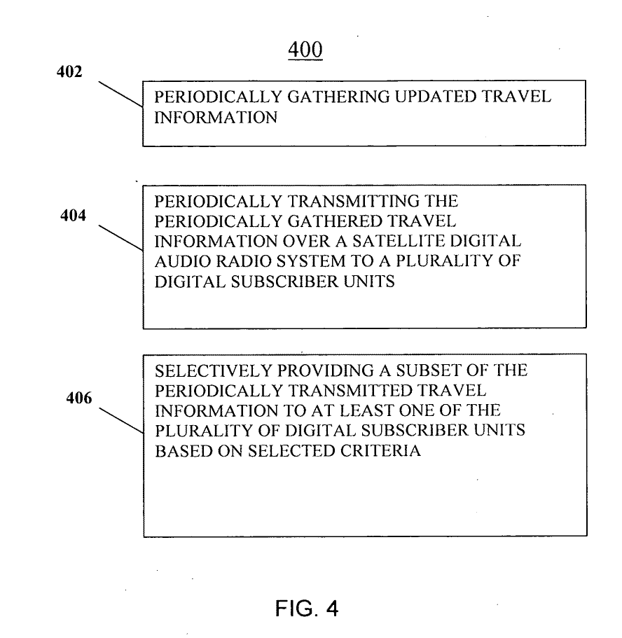

FIG. 4 is a flowchart of an exemplary illustrative process 400 for providing a travel information service. At step 402, updated travel information may be periodically gathered. For example, the travel information may be updated by and acquired from third party data providers. In some embodiments, the travel information may be gathered by a central server.

At step 404, the periodically gathered travel information may be periodically transmitted to a plurality of digital subscriber units. In some embodiments, the travel information may be periodically transmitted over a satellite digital audio radio system, such as those provided by Sirius XM Radio™. At step 406, a subset of the periodically transmitted travel information may be selectively provided to at least one of the plurality of digital subscriber units based on selected criteria.

In some embodiments, the subset of the travel information may be provided to a user through a display user interface of the at least one digital subscriber unit. In some embodiments, the travel information may include parking garage availability information. In other embodiments, the travel information may include airline flight status information. In yet other embodiments, the travel information may include fuel station pricing information.

It is understood that the steps shown in process 400 of FIG. 4 are merely illustrative and that existing steps may be modified or omitted, additional steps may be added, and the order of certain steps may be altered.

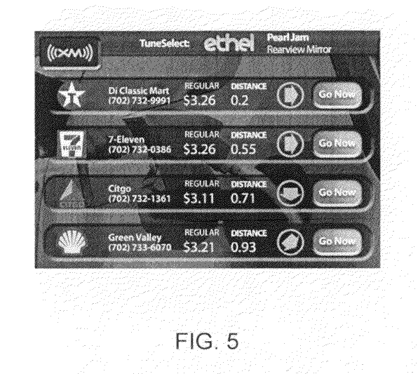

FIG. 5 depicts an exemplary screen shot from an exemplary Fuel Data Service implemented on an XM SDARS receiver according to an exemplary embodiment of the present invention. With reference thereto, visible are a list of four gas stations, their telephone numbers, fuel prices and distance from current position. Additionally shown are arrow icons, indicating in which direction the gas station lies, and a “GO NOW” interactive button, which when pressed causes an integrated navigation system to direct the user to such destination.

The described embodiments of the invention are presented for the purpose of illustration and not of limitation. It will thus be seen that the objects set forth above, among those made apparent from the preceding description, are efficiently attained, and since certain changes may be made in the above processes and constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween. Furthermore, since numerous modifications and variations will readily occur to those skilled in the art, it is not desired that the present invention be limited to the exact construction and operation illustrated and described. Accordingly, all suitable modifications and equivalents, which may be resorted to, are intended to fall within the scope of the claims.

It is to be further understood that while alternate embodiments may not have been presented for every portion or component of the invention, and that the instant invention can compose many different combinations of described portions, or that other undescribed alternate embodiments may be available or substituted for a described portion, such is not to be considered a disclaimer of those alternate embodiments. It will be appreciated that many of those undescribed embodiments are within the literal scope of the following claims, and others are equivalent. Again, it is recognized that the order or sequence of tasks illustrated in the examples and the attached figures are merely intended to be exemplary of the concepts defined herein.

What is claimed:

1. A method comprising:
gathering parking service availability updates and parking garage information; and
conveying near real-time updates of available parking spaces in parking garages to a plurality of mobile subscribers using a satellite digital radio.

2. The method of claim 1, wherein the method further comprises conveying a baseline database of parking garage information to the plurality of mobile subscribers.

3. The method of claim 1, wherein the method further comprises providing information enabling a selection of a parking garage with a highest probability of having a parking space available.

4. The method of claim 1, wherein the conveying comprises presenting parking information to a user through a user interface.

5. The method of claim 1, wherein the conveying comprises providing navigation instructions to a user to a selected parking garage or a selected parking space.

6. The method of claim 1, wherein the method further comprises authorizing and billing for a service providing the parking space availability updates.

7. A system comprising:
a server maintained by a satellite broadcasting entity that ingests parking source data and formats the data for transmission over the air; and
a processor coupled to the server, wherein the processor is programmed to:
enable the compiling and editing of the ingested parking source data;
compile updates to parking garage databases; and
control relative bandwidth allocated for parking garage database updates and parking space availability updates.

8. The system of claim 7, wherein the system further comprises a plurality of mobile subscribers that receives the parking garage updates and parking space availability updates.

9. The system of claim 8, wherein the plurality of mobile subscribers comprise a plurality of satellite digital audio radio system units having a user interface for presenting parking data to an end user.

10. A method, comprising:
acquiring flight status updates;
acquiring flight schedule information;
providing a baseline database of airline and airport information to provision mobile subscriber units with such information;
transmitting over a satellite digital audio radio system updates to a flight arrival/departure status;
transmitting over the satellite digital audio radio system updates to the database of flight schedule information; and
transmitting over the satellite digital audio radio system updates to the baseline database of airline and airport information.

11. The method of claim 10, wherein the flight status updates are acquired from third party data providers.

12. The method of claim 10, wherein the flight schedule information comprises one or more of an airline, a flight number, departure/arrival airports, schedule departure/arrive times, and dates obtained from third party data providers.

13. The method of claim 10, wherein the method further provisions a mobile subscriber for a flight status and flight schedule service.

14. The method of claim 13, wherein the method authorizes and bills a user for the flight status and flight schedule service.

15. A system, comprising:
a server that ingests flight source data and formats the data for transmission over the air; and
a processor coupled to the server, wherein the server operates to:
compile, edit, and attribute the ingested flight data;
compile updates to airline and airport databases; and
control relative bandwidth allocated for flight database updates versus flight status updates.

16. The system of claim 15, wherein the server is maintained by a satellite digital audio radio system provider.

17. The system of claim 15, wherein the system ingest flight data from third-party providers.

18. The system of claim 15, wherein the system comprises a plurality of mobile subscribers each having a user interface for presenting flight data to an end user.

19. The system of claim 15, wherein the system comprises a persistent, updatable storage having:
airline names, two-letter codes, logos, and phone numbers;
airport names, three-letter codes, navigable addressed, and latitude and longitude location; and
flight schedule information having arrival/destination airports, arrival/departure schedule times, airline identifiers, flight numbers, and code-sharing references.

20. The system of claim 19, wherein the system comprises a persistent, updatable storaging further having flight schedule data and listing codeshare flights.

21. The system of claim 19, wherein the system comprises a persistent, updatable storaging further having attributes for optional text and logo banner.

22. A method of providing a fuel information service, comprising:
gathering fuel pricing, fuel type, and fueling station location information;
transmitting a baseline of fuel data information to a plurality of digital subscriber units;
periodically updating the fuel data information;
broadcasting fuel data information in a digital system to the plurality of digital subscriber units; and
selectively providing preferred fueling stations based on criteria selected from current location, track, pricing, fuel type and preferred brand.

23. The method of claim 22, wherein the gathering of fuel pricing, fuel type, and fueling station location information is done at a central server.

24. The method of claim 23, wherein the step of periodically updating the fuel data server is also done at the central server.

25. The method of claim 22, wherein the method provides navigational directions to a selected fuel station.

26. The method of claim 22, wherein the plurality of digital subscriber units are a plurality of satellite digital audio radio system (SDARS) units and the method transmits fuel data information to the plurality of SDARS unit using a satellite digital audio radio system.

27. The method of claim 22, wherein the method further enables a user to set a threshold price for fuel.

28. The method of claim 27, wherein the method alerts a user in a vehicle when the vehicle is low on gas and passed within a predetermined distance to a refueling station with a price lower than the threshold price for fuel set by the user.

29. The method of claim 22, wherein the step of selectively providing preferred fueling stations is based on vehicle location proximity to a fueling station, a navigation route of the vehicle, by zip code, and/or by attributes such as preferred brand, type of fuel, favorite stations, easy access to highway, repair facilities, convenience store, restaurant, etc.

30. A fuel information service system, comprising:
a server that gathers fuel information;
a satellite transmission system that broadcasts fuel data information in a digital stream to a plurality of subscriber units; and
a user interface that enables a user to selectively enter preferences and choose fueling station locations based on criteria selected from current location, track, pricing, fuel type and preferred brand.

31. The fuel information service system of claim 30, wherein the satellite transmission system broadcasts baseline information and updates.

32. The fuel information service system of claim 30, wherein the system further includes a voice control system and a text to speech response system.

33. The fuel information service system of claim 30, wherein the plurality of subscriber units satellite digital audio radio system receivers capable of receiving both audio and data.

34. A method of providing a travel information service, comprising:
periodically gathering updated travel information;
periodically transmitting over a satellite digital audio radio system the periodically gathered travel information to a plurality of digital subscriber units; and
selectively providing a subset of the periodically transmitted travel information to at least one of the plurality of digital subscriber units based on selected criteria.

35. The method of claim 34, wherein the travel information comprises parking garage availability information.

36. The method of claim 34, wherein the travel information comprises airline flight status information.

37. The method of claim 34, wherein the travel information comprises fuel station pricing information.

38. A method comprising:
gathering parking service availability updates and parking garage information; and
conveying near real-time updates of available parking spaces in parking garages to a plurality of mobile subscribers via a wireless transmission.

39. A method, comprising:
acquiring flight status updates;
acquiring flight schedule information;
providing a baseline database of airline and airport information to provision mobile subscriber units with such information;
transmitting over a wireless channel updates to a flight arrival/departure status;
transmitting over the wireless channel updates to the database of flight schedule information; and
transmitting over the Wireless channel updates to the baseline database of airline and airport information.
